(19) United States
(12) Patent Application Publication
(10) Pub. No.: US 2014/0195300 A1
(43) Pub. Date: Jul. 10, 2014

(54) SITE OF INTEREST EXTRACTION DEVICE, SITE OF INTEREST EXTRACTION METHOD, AND COMPUTER-READABLE RECORDING MEDIUM

(71) Applicants: Yuki Chiba, Tokyo (JP); Yoji Miyazaki, Tokyo (JP)

(72) Inventors: Yuki Chiba, Tokyo (JP); Yoji Miyazaki, Tokyo (JP)

(73) Assignee: NEC Corporation, Minato-ku, Tokyo (JP)

(21) Appl. No.: 14/238,882

(22) PCT Filed: Jul. 23, 2012
(86) PCT No.: PCT/JP2012/068606

§ 371 Date: Feb. 14, 2014

(30) Foreign Application Priority Data
Aug. 15, 2011 (JP) 2011-177512

(51) Int. Cl. G06Q 30/02

(52) U.S. Cl. CPC G06Q 30/0201
USPC 705/7.29

(57) ABSTRACT

A site of interest extraction apparatus (10) includes: a passage section identification unit (4) that, for each user (20), renders a virtual line on a map using position information and direction information based on map information and on grid information identifying a plurality of sections, and identifies sections through which the virtual line passes, the position information and direction information being acquired for each user from a terminal device (21) owned by the user, and the virtual line being defined by the position information and direction information; an interest degree calculation unit (5) that, for each identified section, calculates an interest degree by adding a score in accordance with the virtual lines passing through the section; and a site of interest extraction unit (6) that selects one section based on the interest degrees and extracts the selected section as a site of interest to a plurality of users (20).

### TECHNICAL FIELD

The present invention relates to a site of interest extraction apparatus and a site of interest extraction method that extract a site of interest to a plurality of users, and to a computer-readable recording medium having recorded therein a program for realizing the apparatus and the method.

### BACKGROUND ART

In recent years, attention is drawn to attempts to extract a target of interest to many people based on behaviors of real-world users with the use of various sensors. In view of this, for example, methods have been proposed for extracting a target of interest to people by identifying an object or a place at which people are gazing (see, for example, Patent Document 1 and Patent Document 2).

More specifically, Patent Document 1 discloses an apparatus that extracts a target of interest to a user. The apparatus disclosed in Patent Document 1 first estimates the position and the line of sight of a user with the use of a laser rangefinder or a camera, and then identifies a site at which the user is gazing from the estimated line of sight. Thereafter, the apparatus disclosed in Patent Document 1 extracts a target of interest to the user by comparing the identified site with map information prepared in advance.

On the other hand, Patent Document 2 discloses an apparatus that searches for a facility sought for by a user with the use of position information and direction information of the user. First, the apparatus disclosed in Patent Document 2 determines the direction in which the user is facing with the use of the position information and the direction information of the user, and identifies an area existing along the determined direction. Thereafter, the apparatus disclosed in Patent Document 2 searches for facilities from the identified area, displays the facilities, makes the user select a facility of interest to the user, and displays detailed information of the selected facility.

### CITATION LIST

### Patent Document

Patent Document 1: JP 2005-006897A
Patent Document 2: JP 2007-525042A

### DISCLOSURE OF THE INVENTION

### Problem to be Solved by the Invention

The apparatus disclosed in Patent Document 1 is extremely useful for a user as it automatically extracts a facility of interest to the user. However, the apparatus disclosed in the Patent Document 1 requires a special device in order to identify a site at which the user is gazing, and therefore gives rise to the problem that the overall cost for the apparatus increases significantly. This problem will be specifically described below.

First of all, in order to identify a site at which a user is gazing from the line of sight of the user, position information for identifying the position of the user and direction information for identifying the direction of the line of sight of the user are required. The position information and the direction information of the user can be acquired in a relatively inexpensive and easy manner using, for example, a GPS and an electronic compass.

However, these two pieces of information, that is to say, the position information and the direction information, merely enable identification of the line of sight of the user, and do not enable identification of the site at which the user is gazing along the line of sight. Therefore, in order to identify the site at which the user is gazing, distance information for identifying a distance from the user to the site at which the user is gazing is required in addition to the position information and the direction information.

For this reason, the aforementioned apparatus disclosed in Patent Document 1 acquires the distance information using a special device such as a laser rangefinder. As a result, the overall cost for the apparatus increases significantly.

On the other hand, the apparatus disclosed in Patent Document 2 does not require a special device, but identifies an extremely broad area as it cannot acquire distance information. Therefore, the apparatus disclosed in Patent Document 2 gives rise to the problem that the user must experience the effort and burden in selecting a facility.

There are other methods for acquiring distance information. One known method is to make a user gaze at an object and a place of interest to the user from two sites of different positions, and estimate a distance to the target of the gaze from pair data, which includes the position information and the direction information acquired in each site, using the principle of binocular disparity. However, if this method is adopted, the user must experience the effort and burden similarly to the case of Patent Document 2.

Still another known method for acquiring distance information is to use a device that keeps track of the eye movement of a user and a camera that acquires an image representing the angle of view of the user, and estimate a distance to the target of the gaze by applying image processing to data acquired by the device and the camera. However, if this method is adopted, the cost for the apparatus increases similarly to the case of Patent Document 1.

Furthermore, it is an object of both of the aforementioned apparatuses disclosed in Patent Document 1 and Patent Document 2 to extract a target of interest to an individual user of the apparatuses, and they are not suited for extraction of something in which many people are interested.

### Object of Invention

One exemplary object of the present invention is to provide a site of interest extraction apparatus, a site of interest extraction method, and a computer-readable recording medium that solve the aforementioned problems and can extract a site of interest to many people in an inexpensive manner without causing a user to experience the effort and burden.

### Means for Solving the Problem

In order to achieve the above object, a site of interest extraction apparatus in one aspect of the present invention extracts a site of interest to a plurality of users and includes: a passage section identification unit that, for each user, renders a virtual line on a map of a specific area using position information and direction information based on map information of the specific area and on grid information identifying a plurality of sections set in the area, and identifies sections through which the virtual line passes, the position information and the direction information being acquired for each user from a device owned by the user and identifying a position of the user and a direction in which the user is facing, respectively, and the virtual line being defined by the position information and the direction information; an interest degree calculation unit that, for each identified section, adds a score in accordance with the virtual lines passing through the section, and calculates the added score as an interest degree; and a site of interest extraction unit that selects one of the identified sections based on the calculated interest degrees, and extracts the selected section as a site of interest to the plurality of users.

Furthermore, in order to achieve the above object, a site of interest extraction method in one aspect of the present invention extracts a site of interest to a plurality of users and includes: (a) a step of, for each user, rendering a virtual line on a map of a specific area using position information and direction information based on map information of the specific area and on grid information identifying a plurality of sections set in the area, and identifying sections through which the virtual line passes, the position information and the direction information being acquired for each user from a device owned by the user and identifying a position of the user and a direction in which the user is facing, respectively, and the virtual line being defined by the position information and the direction information; (b) a step of, for each identified section, adding a score in accordance with the virtual lines passing through the section, and calculating the added score as an interest degree; and (c) a step of selecting one of the identified sections based on the calculated interest degrees, and extracting the selected section as a site of interest to the plurality of users.

Furthermore, in order to achieve the above object, a computer-readable recording medium in one aspect of the present invention has recorded therein a program for extracting a site of interest to a plurality of users using a computer, the program including instructions for causing the computer to execute: (a) a step of, for each user, rendering a virtual line on a map of a specific area using position information and direction information based on map information of the specific area and on grid information identifying a plurality of sections set in the area, and identifying sections through which the virtual line passes, the position information and the direction information being acquired for each user from a device owned by the user and identifying a position of the user and a direction in which the user is facing, respectively, and the virtual line being defined by the position information and the direction information; (b) a step of, for each identified section, adding a score in accordance with the virtual lines passing through the section, and calculating the added score as an interest degree; and (c) a step of selecting one of the identified sections based on the calculated interest degrees, and extracting the selected section as a site of interest to the plurality of users.

### Effects of the Invention

As described above, the present invention enables extraction of a site of interest to many users in an inexpensive manner without causing a user to experience the effort and burden.

### BRIEF DESCRIPTION OF THE DRAWINGS

FIG. 1 is a block diagram showing a configuration of a site of interest extraction apparatus according to a first embodiment of the present invention.

FIG. 2 shows one example of line-of-sight information stored in a line-of-sight information storage unit shown in FIG. 1.

FIG. 3 shows one example of a correspondence relationship between grids and grid IDs stored in a grid information storage unit shown in FIG. 1.

FIG. 4 is a drawing for describing one example of interest degree calculation processing executed by an interest degree calculation unit shown in FIG. 1.

FIG. 5 shows one example of presentation of a site of interest by a site of interest presentation unit shown in FIG. 1.

FIG. 6 is a flow diagram showing the operations of the site of interest extraction apparatus according to the first embodiment of the present invention.

FIG. 7 shows examples of lines of sight acquired in a first working example of the present invention.

FIG. 8 shows a result of calculation of interest degrees in the first working example of the present invention.

FIG. 9 is a block diagram showing a configuration of a site of interest extraction apparatus according to a second embodiment of the present invention.

FIG. 10 is a flow diagram showing the operations of the site of interest extraction apparatus according to the second embodiment of the present invention.

FIG. 11 is a block diagram showing a configuration of a site of interest extraction apparatus according to a third embodiment of the present invention.

FIG. 12 is a diagram for describing the case where a plurality of arbitrary lines of sight exist in the same area.

FIG. 13 shows examples of line-of-sight information and grid ID information stored in a passing line-of-sight information storage unit shown in FIG. 11.

FIG. 14 shows examples of scores calculated from the line-of-sight information shown in FIG. 13.

FIG. 15 is a flow diagram showing the operations of the site of interest extraction apparatus according to the third embodiment of the present invention.

FIG. 16 shows examples of sites at which users are actually gazing in a third working example of the present invention.

FIG. 17 shows examples of lines of sight acquired in the third working example of the present invention.

FIG. 18 shows examples of line-of-sight information and grid ID information stored in a passing line-of-sight information storage unit in the third working example.

FIG. 19 shows one example of interest degree calculation processing according to the third working example.

FIG. 20 shows another example of the interest degree calculation processing according to the third working example.

FIG. 21 is a block diagram showing one example of a computer that realizes the site of interest extraction apparatuses according to the first to third embodiments of the present invention.

### DESCRIPTION OF EMBODIMENTS

### First Embodiment

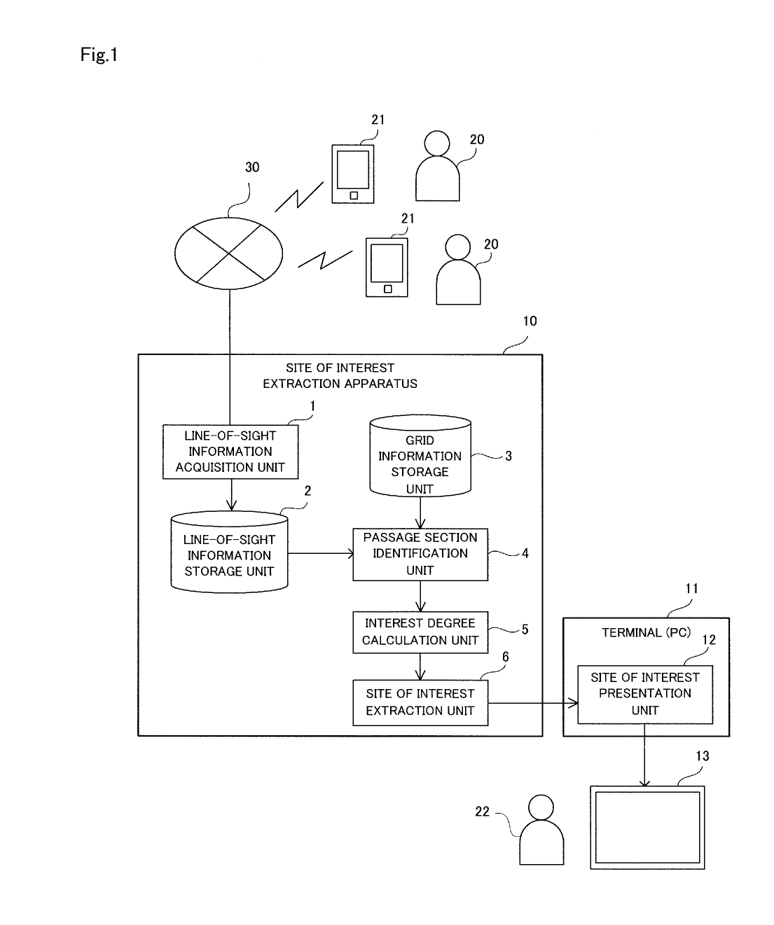

The following describes a site of interest extraction apparatus, a site of interest extraction method and a program according to a first embodiment of the present invention with reference to FIGS. 1 to 6.

Apparatus Configuration

First, a description is given of a configuration of the site of interest extraction apparatus according to the present first embodiment with reference to FIG. 1. FIG. 1 is a block diagram showing the configuration of the site of interest extraction apparatus according to the first embodiment of the present invention.

A site of interest extraction apparatus 10 according to the present first embodiment shown in FIG. 1 extracts a site of interest to a plurality of users 20 in response to an instruction from a customer 22 who seeks to extract the site of interest.

As shown in FIG. 1, in the present first embodiment, the site of interest extraction apparatus 10 is connected to terminal devices 21 owned by the users via a network 30. Specific examples of the terminal devices 21 include mobile telephones, smartphones, personal computers with communication functions, and the like. Examples of the network 30 include a mobile telephone communication network, a wireless LAN communication network, and the like.

Furthermore, as shown in FIG. 1, the site of interest extraction apparatus 10 mainly includes a passage section identification unit 4, an interest degree calculation unit 5, and a site of interest extraction unit 6. Among these, the passage section identification unit 4 uses position information and direction information that are acquired from the terminal devices 21 owned by the users 20 on a per-user 20 basis. The position information identifies the positions of the users 20, and the direction information identifies the directions in which the users 20 are facing.

Then, based on map information of a specific area and on grid information identifying a plurality of sections set in this specific area, the passage section identification unit 4 renders, on a per-user basis, virtual lines defined by the position information and the direction information on a map of the specific area. At the time of rendering, the passage section identification unit 4 also identifies sections through which the virtual lines pass.

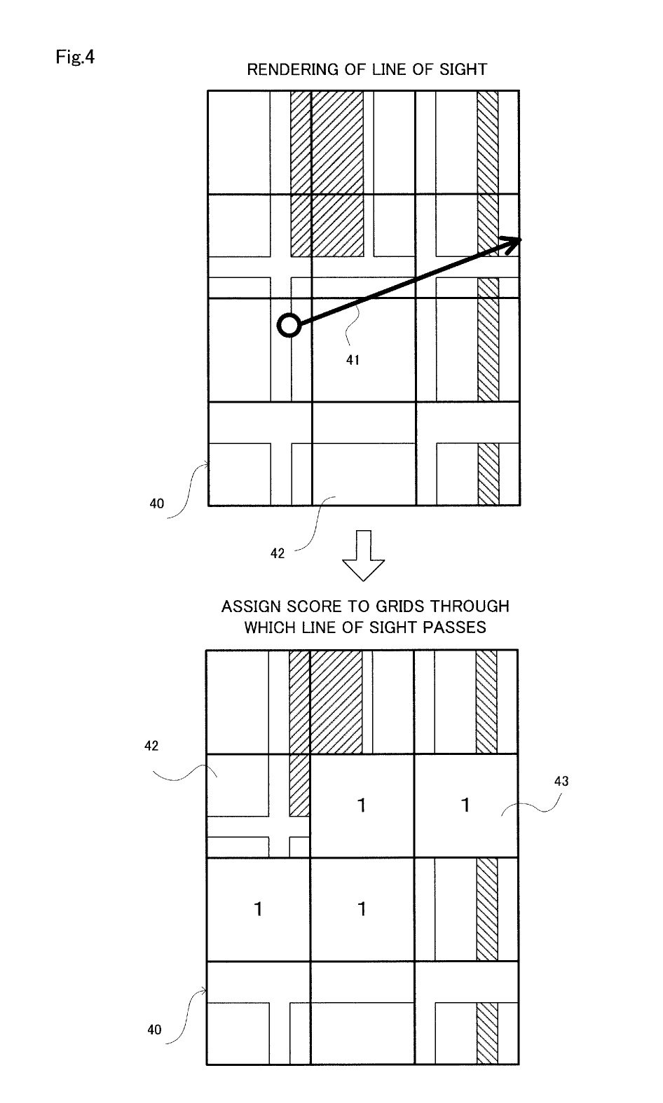

As shown in FIG. 4 to be described later, a virtual line is rendered as an arrow extending from a start point, which is a position identified by the position information, in a direction identified by the direction information, and represents a line of sight of a user. Therefore, in the following description, a virtual line will be referred to as a “line of sight”.

For each section identified by the passage section identification unit 4, the interest degree calculation unit 5 adds a score in accordance with lines of sight that pass through the section, and calculates the added score as an interest degree. The site of interest extraction unit 6 selects one of the identified sections based on the calculated interest degrees, and extracts the selected section as a site of interest to the plurality of users 20 (hereinafter referred to as a “site of interest”).

As described above, in the present first embodiment, the site of interest extraction apparatus 10 can extract a site of interest to many users 20 without requiring a selecting operation by the customer 22 who seeks to extract the site of interest. Therefore, the customer 22, who is to use the site of interest, need not experience the effort and burden. Furthermore, the site of interest is extracted by rendering lines of sight of the users 20 on a map, and the lines of sight can be rendered using only two pieces of information, that is to say, the position information and the direction information. Therefore, it is not necessary to acquire distance information using a special device, and the site of interest can be extracted in an inexpensive manner.

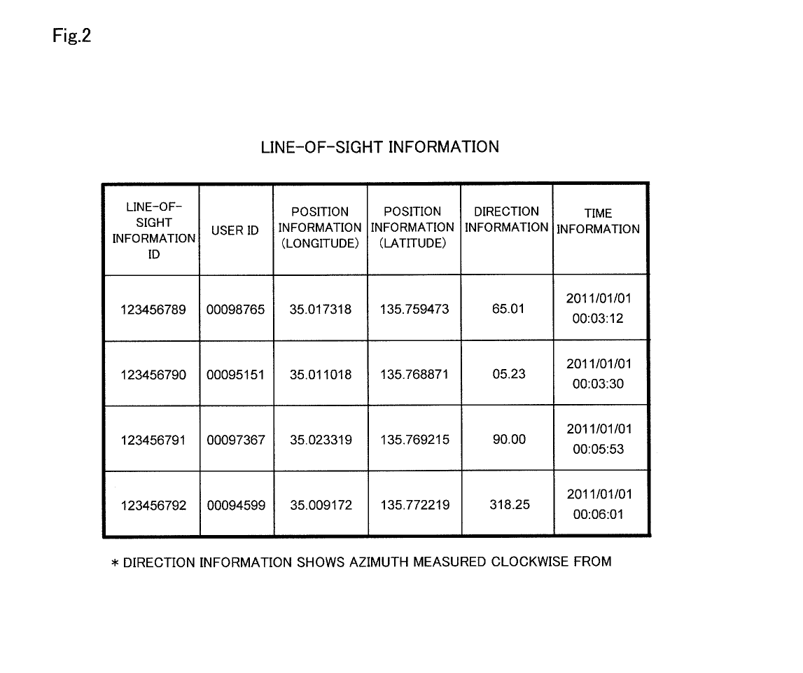

The following describes the configuration of the site of interest extraction apparatus 10 according to the present first embodiment in more detail with reference to FIGS. 2 to 5 in addition to FIG. 1. In the present first embodiment, as shown in FIG. 1, the site of interest extraction apparatus 10 includes a line-of-sight information acquisition unit 1, a line-of-sight information storage unit 2, and a grid information storage unit 3 in addition to the passage section identification unit 4, the interest degree calculation unit 5, and the site of interest extraction unit 6. Furthermore, the site of interest extraction apparatus 10 is connected to a terminal 11 of the customer (service customer) 22 who seeks to extract a site of interest. It should be noted that, in the present first embodiment, the terminal 11 is a computer terminal operated by the customer 22.

In the present first embodiment, the line-of-sight information acquisition unit 1 acquires, on a per-user 20 basis, the position information identifying the positions of the users and the direction information identifying the directions in which the users are facing from the terminal devices 21 of the users 20.

Furthermore, in the present first embodiment, the line-of-sight information acquisition unit 1 inputs the position information and the direction information collected from the terminal devices 21 of the individual users 20 to the line-of-sight information storage unit 2. As shown in FIG. 2, the line-of-sight information storage unit 2 stores the position information and the direction information on a per-user basis. The line-of-sight information storage unit 2 also outputs the line-of-sight information stored therein to the passage section identification unit 4 in response to a request therefrom.

Hereinafter, information including both of the position information identifying the positions of the users and the direction information identifying the directions in which the users are facing is referred to as “line-of-sight information”. In the present first embodiment, it is preferable that the line-of-sight information identifies the positions of the users and the directions in which the users are facing at the time when the users are gazing at some sort of object or place.

Furthermore, as shown in FIG. 2, the line-of-sight information may include, in addition to the position information and the direction information, IDs for identifying the line-of-sight information on a per-user basis (hereinafter referred to as “line-of-sight information IDs”), user IDs for identifying the users, time information showing acquisition times of the position information and the direction information, and the like. In this case, the line-of-sight information IDs, the user IDs, and the time information are stored in the line-of-sight information storage unit 2 in association with the position information and the direction information. FIG. 2 shows one example of the line-of-sight information stored in the line-of-sight information storage unit shown in FIG. 1.

For example, in the case where the terminal devices 21 of the users 20 are communication terminals equipped with GPS modules and electronic compasses (for example, mobile telephones or smartphones), the line-of-sight information can be acquired through the users' operation on their respective communication terminals. More specifically, the users 20 face the directions at which they are gazing while holding their communication terminals in hand, and execute an operation for transmitting the line-of-sight information. In this way, the GPS modules and the electronic compasses in the communication terminals are activated, and the line-of-sight information including the position information and the direction information is acquired. Then, the communication terminals transmit the acquired line-of-sight information to the site of interest extraction apparatus 10 via the mobile telephone communication network. As will be described later, in the present first embodiment, the site of interest extraction apparatus 10 is built in a server computer connected to the communication network.

The grid information storage unit 3 stores the map information of the specific area and the grid information identifying the plurality of sections set in this specific area. The plurality of sections are set such that the specific area on the map is divided in a grid-like pattern. In the following description, the sections are referred to as “grids”. Furthermore, the grid information storage unit 3 outputs the map information and the grid information stored therein to the passage section identification unit 4 in response to a request therefrom.

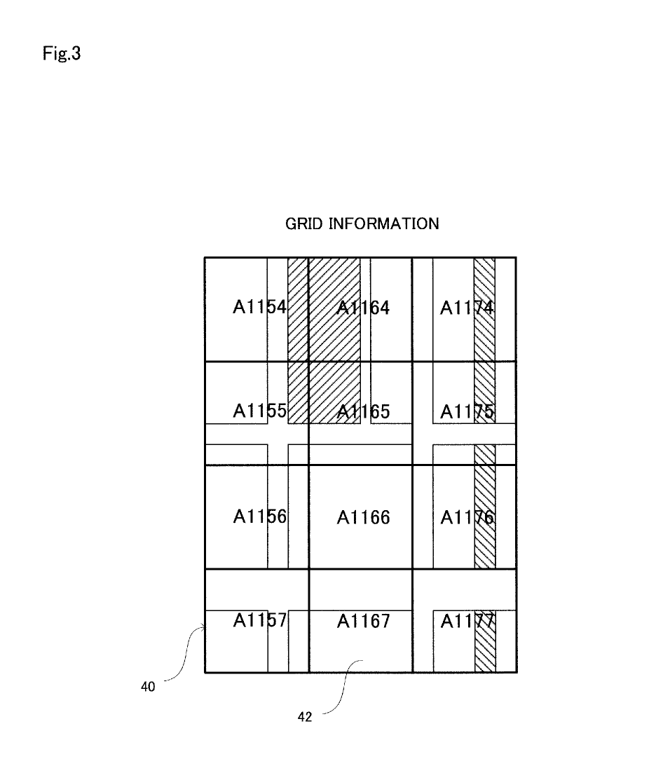

A description is now given of the grid information with reference to FIG. 3. FIG. 3 is a drawing for describing one example of the grid information stored in the grid information storage unit shown in FIG. 1. As shown in FIG. 3, a plurality of grids 42 are set in a specific area (map 40). Furthermore, as shown in FIG. 3, each grid 42 is preassigned an ID for distinguishing the same (hereinafter referred to as a “grid ID”). The grid information storage unit 3 also stores information for identifying the grid ID, the size, and the position on a per-grid basis.

Furthermore, in the present first embodiment, the size of the grids stored in the grid information storage unit 3 is not limited to one type. For example, a plurality of types of grids of different sizes, such as grids 100 m on a side, grids 500 m on a side, and grids 1000 m on a side, may be set in the same area. In this case, the grid information identifies the plurality of types of grids divided in different ways.

In such a case, it is preferable that the later-described passage section identification unit 4 accepts, from an administrator of the site of interest extraction apparatus 10 (a provider of a site of interest extraction service) or the service customer 22, a selection of the size of the grids corresponding to the scale of a site of interest to be extracted. The grid information storage unit 3 then outputs grid information corresponding to the selected size.

Furthermore, while the examples of FIG. 3 and subsequent figures only show rectangular grids for the sake of simplicity, the grids are not limited to having a rectangular shape in the present first embodiment. In the present first embodiment, the shape of the grids can be selected as appropriate, and the grids may have shapes other than the rectangular shape, such as a rhombic shape, a hexagonal shape, and other polygonal shapes. Alternatively, the grids may have shapes corresponding to administrative districts, such as cities, towns, and villages. The above description related to the grids applies similarly in other embodiments to be discussed later.

In the present embodiment, the passage section identification unit 4 first acquires the line-of-sight information stored in the line-of-sight information storage unit 2 and the grid information stored in the grid information storage unit 3. The passage section identification unit 4 then uses the position of each user 20 identified by the position information as the start point of the line of sight of the user 20. As an end point of the line of sight is not uniquely determined only from the line-of-sight information, the passage section identification unit 4 sets the end point based on a preset condition for the end point.

Specific examples of the condition for the end point include a condition in which the number of grids through which the line of sight passes has equaled the upper limit, and a condition in which a distance from the start point has equaled a distance that is considered to be the upper limit of the field of view that a person can generally observe, such as 5 km and 10 km.

Thereafter, as shown in FIG. 4, the passage section identification unit 4 renders a line of sight 41 of the user 20 on the map 40 of the specific area, identifies grids 43 through which the line of sight 41 has passed, and notifies the interest degree calculation unit 5 of the grid IDs of the identified grids 43. More specifically, the passage section identification unit 4 outputs, to the interest degree calculation unit 5, information for identifying the grid IDs to be notified. FIG. 4 is a drawing for describing one example of interest degree calculation processing executed by the interest degree calculation unit shown in FIG. 1.

The interest degree calculation unit 5 adds a certain score for all of the grids identified by the passage section identification unit 4. For example, as shown in FIG. 4, the interest degree calculation unit 5 adds a score for all of the grids 43 through which the rendered line of sight passes.

The passage section identification unit 4 and the interest degree calculation unit 5 repeatedly execute the aforementioned processing for each one of the lines of sight stored in the line-of-sight information storage unit 2. As a result, for a grid through which a plurality of lines of sight pass, a score corresponding to the number of the passing lines of sight is added. Therefore, a grid through which a larger number of lines of sight have passed shows a higher score. In the present first embodiment, the score of each grid acquired in the above manner is calculated as the aforementioned “interest degree”. The interest degree calculation unit 5 also outputs all of the calculated interest degrees of the grids to the site of interest extraction unit 6. In the present first embodiment, the site of interest extraction unit 6 extracts a grid with a high interest degree from among the grids output by the interest degree calculation unit 5 as a site of interest. More specifically, the site of interest extraction unit 6 may, for example, compare the interest degrees of the grids with one another, rearrange the grids in order of highest interest degree, and extract grids in order of rearrangement as sites of interest. Alternatively, the site of interest extraction unit 6 may extract only grids of set ranks in order of highest interest degree as sites of interest.

Furthermore, the site of interest extraction unit 6 outputs, to the terminal 11, information for identifying the extracted grids with high interest degrees, such as position information and grid ID information of the grids.

The terminal 11 includes a site of interest presentation unit 12. In the present first embodiment, the terminal 11 is a computer terminal as described above, and the site of interest presentation unit 12 is configured by a program. Based on the information output from the site of interest extraction unit 6, the site of interest presentation unit 12 presents the grid with the high interest degree, that is to say, the site of interest, to the customer 22.

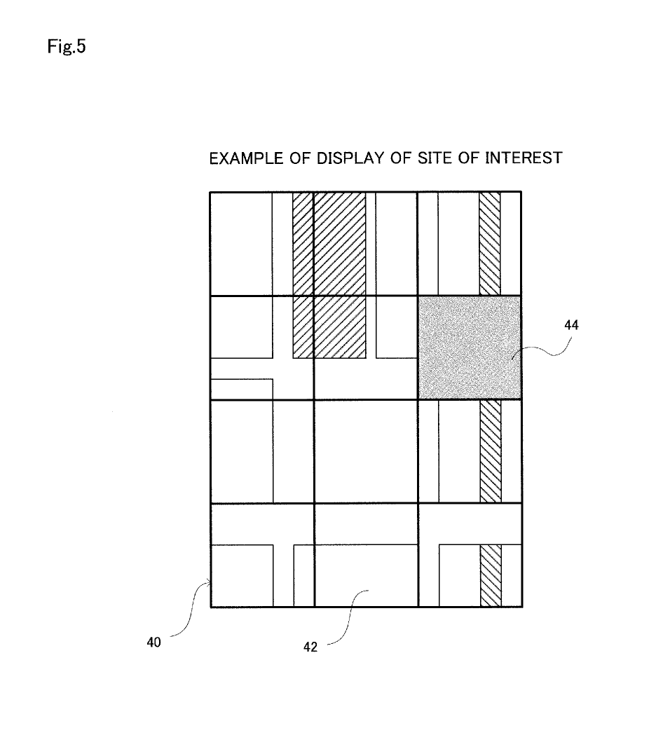

More specifically, for example, as shown in FIG. 5, the site of interest presentation unit 12 displays a grid 44 extracted as a site of interest composited with the map 40 on a screen of a display device 13 connected to the terminal device 11. At this time, the site of interest presentation unit 12 may apply coloring to the grid 44 extracted as the site of interest so as to allow clear distinction between this grid and other grids 42. FIG. 5 shows one example of presentation of a site of interest by the site of interest presentation unit shown in FIG. 1.

In addition, the site of interest presentation unit 12 may, for example, present information such as the names of cities, towns and villages and the names of landmarks around the center of the grid extracted as the site of interest as character information. In this case, the terminal 11 acquires the character information such as the names of cities, towns and villages and the names of landmarks by, for example, communicating with an external map information database and the like.

Apparatus Operations

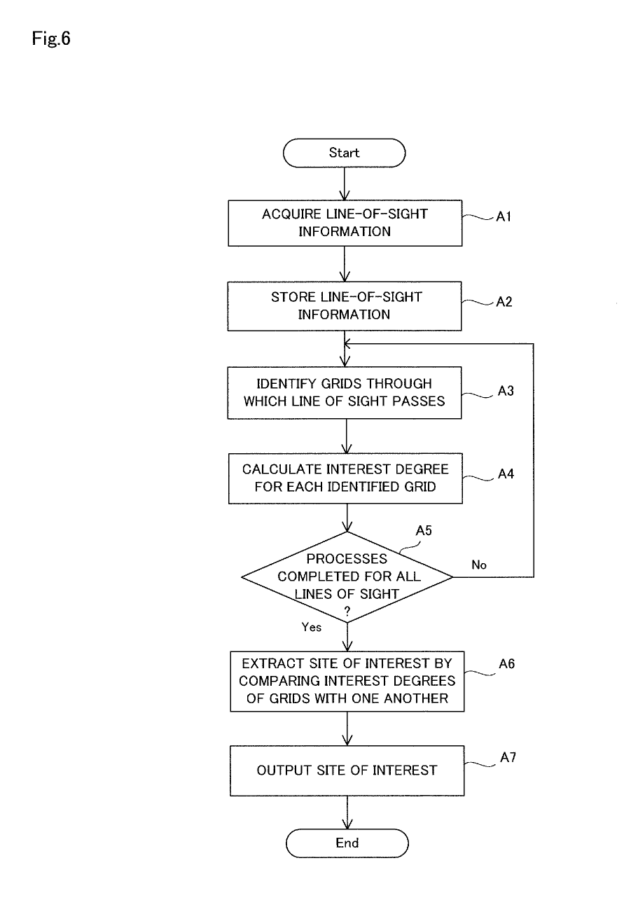

The operations of the site of interest extraction apparatus 10 according to the first embodiment of the present invention will now be described with reference to FIG. 6. FIG. 6 is a flow diagram showing the operations of the site of interest extraction apparatus according to the first embodiment of the present invention. In the following description, FIG. 1 will be referred to where appropriate. In the present first embodiment, the site of interest extraction method is implemented by causing the site of interest extraction apparatus 10 to operate. Therefore, the following description of the operations of the site of interest extraction apparatus 10 applies to the site of interest extraction method according to the present first embodiment.

First, as shown in FIG. 6, in the site of interest extraction apparatus 10, the line-of-sight information acquisition unit 1 acquires the position information and the direction information from the terminal device (communication terminal) 21 of each user 20, and outputs the acquired position information and direction information to the line-of-sight information storage unit 2 (step A1).

Next, the line-of-sight information storage unit 2 stores the position information and the direction information output from the line-of-sight information acquisition unit 1 as the line-of-sight information (step A2). At this time, the line-of-sight information storage unit 2 assigns the line-of-sight information ID and the user ID to the line-of-sight information as shown in FIG. 2.

Thereafter, with the use of the line-of-sight information stored in the line-of-sight information storage unit 2 and the grid information stored in the grid information storage unit 3, the passage section identification unit 4 renders a line of sight of the user 20 on the map of the specific area in which the grids are set, and identifies grids through which the line of sight passes (step A3).

Then, the interest degree calculation unit 5 assigns a score for calculating the interest degrees to the grids identified in step A3, and calculates the interest degrees (step A4). Upon completion of step A4, the interest degree calculation unit 5 determines whether or not steps A3 and A4 have been completed for all lines of sight (step A5).

If the result of determination in step A5 shows that steps A3 and A4 have not been completed for all lines of sight, step A3 is executed again. On the other hand, if the result of determination in step A5 shows that steps A3 and A4 have been completed for all lines of sight, step A6 is executed.

Next, in step A6, the site of interest extraction unit 6 compares the interest degrees that the interest degree calculation unit 5 calculated on a per-grid basis, and extracts a grid with a high interest degree as a site of interest.

Subsequently, the site of interest extraction unit 6 outputs the extracted site of interest to the terminal 11 (step A7). Consequently, the site of interest presentation unit 12 displays the site of interest extracted by the site of interest extraction unit 6 on a display screen of the display device 13, thereby presenting the same to the service customer 22.

Program

It is sufficient for the program according to the present first embodiment to cause a computer to execute steps A1 to A7 shown in FIG. 6. The site of interest extraction apparatus 10 and the site of interest extraction method according to the present first embodiment can be realized by installing this program in the computer and executing the installed program. In this case, a CPU (central processing unit) of the computer functions as the line-of-sight information acquisition unit 1, the passage section identification unit 4, the interest degree calculation unit 5 and the site of interest extraction unit 6, and executes processing accordingly. Also, a storage device provided for the computer, such as a hard disk drive, functions as the line-of-sight information storage unit 2 and the grid information storage unit 3.

Furthermore, in the present first embodiment, the line-of-sight information storage unit 2 and the grid information storage unit 3 may be realized by a computer different from the computer in which the program according to the present first embodiment is installed. In this case, the computer in which the program according to the present first embodiment is installed is connected to the computer realizing the line-of-sight information storage unit 2 and the grid information storage unit 3 via a network and the like.

Moreover, in the case where a communication terminal, such as a mobile telephone and a smartphone, has a function of executing programs, the program according to the present first embodiment may be installed in the communication terminal. In this case, a CPU of the communication terminal functions as the passage section identification unit 4, the interest degree calculation unit 5 and the site of interest extraction unit 6, and the site of interest extraction apparatus 10 is configured inside the communication terminal. In this mode, the site of interest presentation unit 12 may be configured inside the communication terminal as well.

It should be noted that, even if the communication terminal functions as the site of interest extraction apparatus 1, it is preferable that the line-of-sight information acquisition unit 1 and the line-of-sight information storage unit 2 are configured by a server computer different from the communication terminal.

While the terminal devices 21 of the users 20 are described as communication terminals equipped with GPS modules and electronic compasses in the above example, the terminal devices 21 are not limited to being communication terminals in the present first embodiment. It is sufficient for the terminal devices 21 to be devices that can acquire the position information and the direction information in an inexpensive manner without using a large-scale configuration, and that do not require operations that lay a burden on the users 20.

Also, in the above example, once the service customer 22 requests the extraction of a site of interest, the interest degrees are calculated by executing steps A1 to A7 using all of the line-of-sight information stored in the line-of-sight information storage unit 2. However, the present first embodiment is not limited to this mode.

For example, the present first embodiment may adopt a mode in which, prior to the request for the extraction of the site of interest, the site of interest extraction apparatus 10 calculates the interest degrees in advance on a per-grid basis using the line-of-sight information stored in the line-of-sight information storage unit 2, and compares the interest degrees of the grids with one another. In this mode, it is preferable that the site of interest extraction apparatus 10 includes a storage unit for storing the interest degrees calculated in advance and the result of comparison between the interest degrees.

If this mode is adopted, once the service customer 22 requests the extraction of the site of interest, the site of interest extraction apparatus 10 can immediately acquire information related to the interest degrees by accessing the storage unit, and therefore the customer 22 can promptly receive information related to the site of interest.

### Effects of First Embodiment

As described above, in the present first embodiment, a site of interest to many people can be extracted in an inexpensive manner without causing a customer who is to use the site of interest to experience the effort and burden. This is because, in the present first embodiment, sites in which lines of sight of many people intersect are identified instead of directly identifying sites at which different individuals are gazing, and a site of interest is extracted based on the identified sites. That is to say, in the present first embodiment, only the line-of-sight information is used that is acquired merely from the position information and the direction information of different individuals, and a special device is not used. Therefore, a site of interest can be extracted in an inexpensive manner. Furthermore, as the customer need not select a site of interest, the effort and burden that the customer experiences are extremely small.

### Second Embodiment

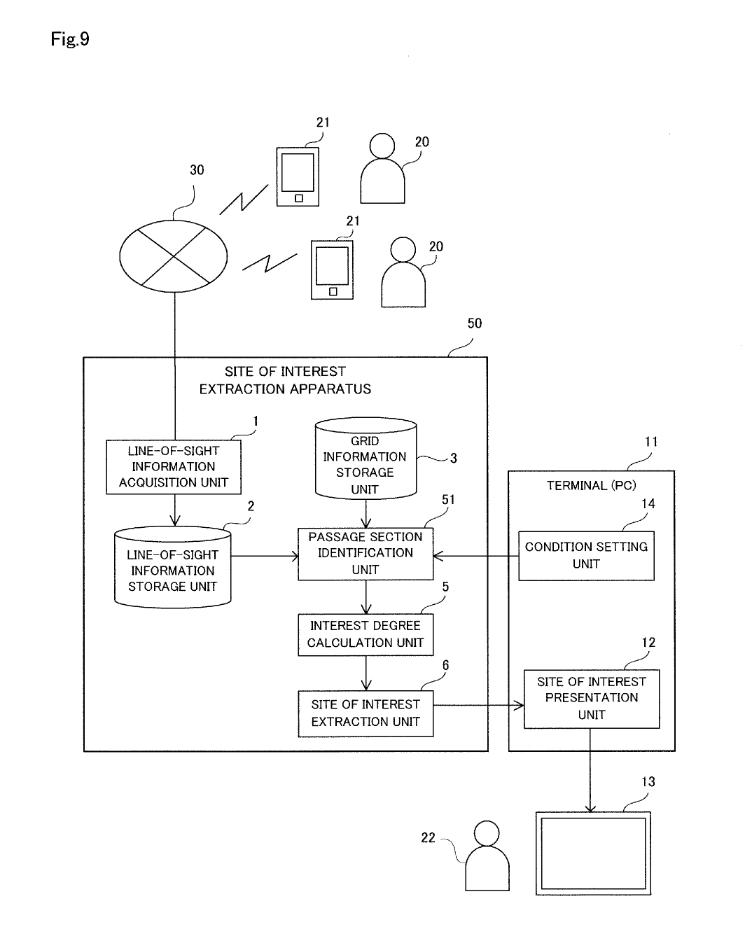

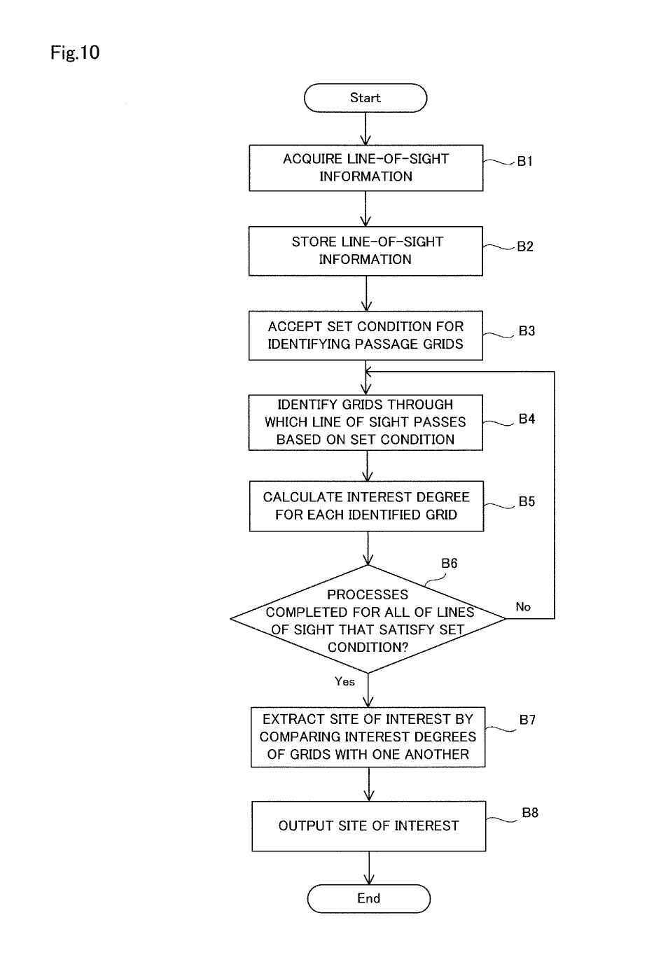

The following is a detailed description of a site of interest extraction apparatus, a site of interest extraction method and a program according to a second embodiment of the present invention with reference to FIGS. 9 and 10.

Apparatus Configuration

First, a description is given of a configuration of the site of interest extraction apparatus according to the present second embodiment with reference to FIG. 9. FIG. 9 is a block diagram showing the configuration of the site of interest extraction apparatus according to the second embodiment of the present invention.

A site of interest extraction apparatus 50 according to the present second embodiment shown in FIG. 9 differs from the site of interest extraction apparatus 10 according to the first embodiment shown in FIG. 1 in the function of a passage section identification unit 51. Also, in the present second embodiment, a terminal 11 of a customer 22 further includes a condition setting unit 14 as shown in FIG. 9. It should be noted that, other than the aforementioned features, the site of interest extraction apparatus 50 according to the present second embodiment is similar to the site of interest extraction apparatus 10 according to the first embodiment, and therefore a description thereof is omitted. The following description will be given with a focus on differences from the first embodiment.

In the first embodiment, the passage section identification unit 4 identifies, for all of the lines of sight stored in the line-of-sight information storage unit 2, grids through which the lines of sight pass. In contrast, in the present second embodiment, the passage section identification unit 51 identifies grids through which lines of sight pass based on a set condition. The set condition is set by the customer 22 and provided to the passage section identification unit 51 via the condition setting unit 14 in the terminal 11.

One example of the set condition for identifying passage grids is a condition in which passage grids are identified using only line-of-sight information that was acquired during a specific time frame out of lines of sight stored in a line-of-sight information storage unit 2. Another example is a condition in which passage grids are identified using only lines of sight that pass through grids within a specific range out of all lines of sight.

The set condition for identifying passage grids is not limited to the above examples. Still another example of the set condition is a condition in which passage grids are identified using only lines of sight of limited target users. For example, provided that line-of-sight information stored in the line-of-sight information storage unit 2 is as shown in FIG. 2, the passage section identification unit 51 may target lines of sight to be used in extracting a site of interest based on user IDs that match a specific condition, and identify passage grids using only the targeted lines of sight.

One example of the specific condition for targeting user IDs is a condition using user attribute information associated with the user IDs. The user attribute information is, for example, information related to users themselves who provide line-of-sight information, such as age groups, sexes, hobbies and preferences of the users. In this case, the use of the user attribute information leads to, for example, selection of users of a specific age group or sex, and selection of users who have a specific hobby or preference.

Furthermore, in the present second embodiment, in the case where the aforementioned user attribute information is used, it is preferable that the site of interest extraction apparatus 50 includes a separate storage unit for storing the user attribute information.

Moreover, in the present second embodiment, the passage section identification unit 51 may use two or more set conditions for identifying passage grids. For example, the passage section identification unit 51 may identify passage grids using lines of sight that belong to users of a specific age group and fall within a specific time frame.

Apparatus Operations

The operations of the site of interest extraction apparatus 50 according to the second embodiment of the present invention will now be described with reference to FIG. 10. FIG. 10 is a flow diagram showing the operations of the site of interest extraction apparatus according to the second embodiment of the present invention. In the following description, FIG. 9 will be referred to where appropriate. In the present second embodiment, the site of interest extraction method is implemented by causing the site of interest extraction apparatus 50 to operate. Therefore, the following description of the operations of the site of interest extraction apparatus 50 applies to the site of interest extraction method according to the present second embodiment.

First, as shown in FIG. 10, in the site of interest extraction apparatus 50, a line-of-sight information acquisition unit 1 acquires position information and direction information from a terminal device (communication terminal) 21 of each user 20, and outputs the acquired position information and direction information to the line-of-sight information storage unit 2 (step B1). Next, the line-of-sight information storage unit 2 stores the position information and the direction information output from the line-of-sight information acquisition unit 1 as line-of-sight information (step B2). Steps B1 and B2 are similar to steps A1 and A2 shown in FIG. 6.

Thereafter, the customer 22 inputs a set condition for identifying passage grids to the terminal 11, the condition setting unit 14 accordingly provides the passage section identification unit 51 with the input set condition, and the passage section identification unit 51 accepts the set condition (step B3).

Subsequently, the passage section identification unit 51 renders a line of sight on a map of a specific area in which grids have been set based on the set condition accepted in step B3 using the line-of-sight information stored in the line-of-sight information storage unit 2 and grid information stored in a grid information storage unit 3, and identifies grids through which the line of sight passes (step B4). More specifically, in step B4, grids through which the line of sight passes are identified with restrictions on users, lines of sight, grids, and the like due to the set condition. Then, an interest degree calculation unit 5 assigns a score for calculating interest degrees to the grids identified in step B4, and calculates the interest degrees (step B5). Steps B5 is similar to step A4 shown in FIG. 6. Upon completion of step B5, the interest degree calculation unit 5 determines whether or not steps B4 and B5 have been completed for all of lines of sight that satisfy the set condition (step B6).

If the result of determination in step B6 shows that steps B4 and B5 have not been completed for all of the lines of sight that satisfy the set condition, step B4 is executed again. On the other hand, if the result of determination in step B6 shows that steps B4 and B5 have been completed for all of the lines of sight that satisfy the set condition, step B7 is executed.

Next, in step B7, a site of interest extraction unit 6 compares the interest degrees that the interest degree calculation unit 5 calculated on a per-grid basis, and extracts a grid with a high interest degree as a site of interest. Subsequently, the site of interest extraction unit 6 outputs the extracted site of interest to the terminal 11 (step B8). Steps B7 and B8 are similar to steps A6 and A7 shown in FIG. 6. Consequently, a site of interest presentation unit 12 displays the site of interest extracted by the site of interest extraction unit 6 on a display screen of a display device 13, thereby presenting the same to the service customer 22.

Program

It is sufficient for the program according to the present second embodiment to cause a computer to execute steps B1 to B8 shown in FIG. 6. The site of interest extraction apparatus 50 and the site of interest extraction method according to the present second embodiment can be realized by installing this program in the computer and executing the installed program. In this case, a CPU (central processing unit) of the computer functions as the line-of-sight information acquisition unit 1, the passage section identification unit 51, the interest degree calculation unit 5 and the site of interest extraction unit 6, and executes processing accordingly. Also, a storage device provided for the computer, such as a hard disk drive, functions as the line-of-sight information storage unit 2 and the grid information storage unit 3.

Furthermore, in the present second embodiment also, the line-of-sight information storage unit 2 and the grid information storage unit 3 may be realized by a computer different from the computer in which the program according to the present second embodiment is installed, similarly to the first embodiment. In this case, the computer in which the program according to the present second embodiment is installed is connected to the computer realizing the line-of-sight information storage unit 2 and the grid information storage unit 3 via a network and the like.

Moreover, in the case where a communication terminal, such as a mobile telephone and a smartphone, has a function of executing programs, the program according to the present second embodiment may be installed in the communication terminal. In this case, a CPU of the communication terminal functions as the line-of-sight information acquisition unit 1, the passage section identification unit 51, the interest degree calculation unit 5 and the site of interest extraction unit 6, and the site of interest extraction apparatus 50 is configured inside the communication terminal. In this mode, the site of interest presentation unit 12 and the condition setting unit 14 may be configured inside the communication terminal as well.

It should be noted that, even if the communication terminal functions as the site of interest extraction apparatus 50, it is preferable that the line-of-sight information acquisition unit 1 and the line-of-sight information storage unit 2 are configured by a server computer different from the communication terminal.

While the terminal devices 21 of the users 20 are described as communication terminals equipped with GPS modules and electronic compasses in the above example, the terminal devices 21 are not limited to being communication terminals in the present second embodiment, similarly to the first embodiment. It is sufficient for the terminal devices 21 to be devices that can acquire the position information and the direction information in an inexpensive manner without using a large-scale configuration, and that do not require operations that lay a burden on the users 20.

Also, in the above example, once the service customer 22 requests the extraction of a site of interest, the interest degrees are calculated by executing steps B1 to B8 using all of the line-of-sight information stored in the line-of-sight information storage unit 2. However, the present second embodiment is not limited to this mode.

For example, similarly to the first embodiment, the present second embodiment may also adopt a mode in which, prior to the request for the extraction of the site of interest, the site of interest extraction apparatus 50 calculates the interest degrees in advance on a per-grid basis using the line-of-sight information stored in the line-of-sight information storage unit 2, and compares the interest degrees of the grids with one another. In this mode, it is preferable that the site of interest extraction apparatus 50 includes a storage unit for storing the interest degrees calculated in advance and the result of comparison between the interest degrees.

If this mode is adopted, once the service customer 22 requests the extraction of the site of interest, the site of interest extraction apparatus 50 can immediately acquire information related to the interest degrees by accessing the storage unit, and therefore the customer 22 can promptly receive information related to the site of interest.

### Effects of Second Embodiment

As described above, according to the present second embodiment, a condition can be set in identifying grids through which lines of sight pass, thereby enabling the identification of grids through which lines of sight pass based on arbitrary users, lines of sight, grids, and the like. In this way, lines of sight, grids, and the like that are unnecessary for the customer can be eliminated. Consequently, the customer can reliably acquire site-of-interest information needed. Furthermore, the effects described in the first embodiment can be achieved also in the present second embodiment.

### Third Embodiment

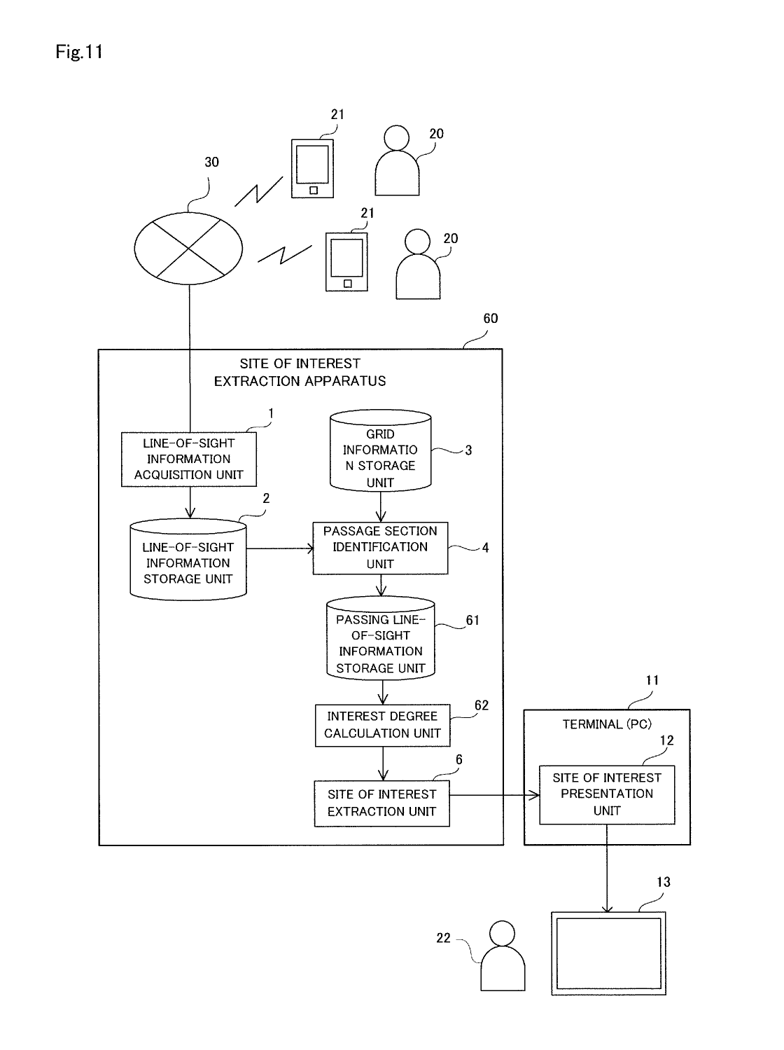

The following is a detailed description of a site of interest extraction apparatus, a site of interest extraction method and a program according to a third embodiment of the present invention with reference to FIGS. 11 to 15.

Apparatus Configuration

First, a description is given of a configuration of the site of interest extraction apparatus according to the present third embodiment with reference to FIGS. 11 to 14. FIG. 11 is a block diagram showing the configuration of the site of interest extraction apparatus according to the third embodiment of the present invention.

A site of interest extraction apparatus 60 according to the present third embodiment shown in FIG. 11 differs from the site of interest extraction apparatus 10 according to the first embodiment shown in FIG. 1 in including a passing line of sight storage unit 61 and in the function of an interest degree calculation unit 62. It should be noted that, other than the aforementioned features, the site of interest extraction apparatus 60 according to the present third embodiment is similar to the site of interest extraction apparatus 10 according to the first embodiment, and therefore a description thereof is omitted. The following description will be given with a focus on differences from the first embodiment.

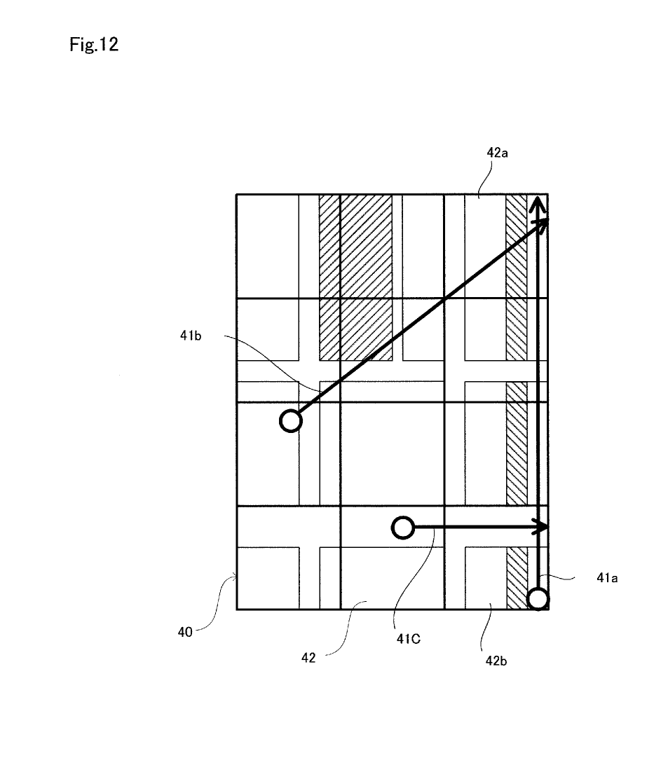

First, a description is given of the premise of the present third embodiment with reference to FIG. 12. FIG. 12 is a diagram for describing the case where a plurality of arbitrary lines of sight exist in the same area. It will be assumed that, as shown in FIG. 12, a plurality of grids 42 are set in a specific area (map 40). Focusing on a grid 42a included among the plurality of grids 42, two or more lines of sight pass through the grid 42a. More specifically, lines of sight 41a and 41b, which are not parallel to each other, pass through the grid 42a.

There is a high possibility that users 20 of the two lines of sight 41a and 41b are gazing at the same object or place existing in the grid 42a. Therefore, it can be considered that this grid 42a is a site that has a high possibility of being of interest to both of the users 20.

Incidentally, if two lines of sight are arbitrarily selected from among a large number of lines of sight acquired, these two lines of sight intersect in one grid for certain, unless they are parallel to each other. For example, with regard to a line of sight 41c which is different from the lines of sight 41a and 41b, the line of sight 41c intersects the line of sight 41a in a grid 42b as shown in FIG. 12. In this case, according to the example of FIG. 12, it can be considered that the grids 42a and 42b have the comparable degrees of possibility of being of interest to the users 20, because two lines of sight pass through each of the grids 42a and 42b.

In this case, focusing on the line of sight 41a, it passes through both of the grids 42a and 42b. Therefore, the grids 42a and 42b may be regarded to be of interest to many users 20.

However, users generally gaze only at one point. Therefore, in this case, it is not accurate to regard both of the grids 42a and 42b as the sites of interest to many users 20 based on the line of sight 41a.

On the other hand, even in the case of FIG. 12, the site of interest extraction apparatus 60 according to the present third embodiment can extract a grid that is considered to be of interest to many users with higher accuracy using the passing line of sight storage unit 61 and the interest degree calculation unit 62.

More specifically, in the present third embodiment, once a passage section identification unit 4 identifies grids through which a line of sight has passed, it outputs, to the passing line-of-sight information storage unit 9, line-of-sight information of the line of sight that has passed and grid ID information of all of the grids through which the line of sight has passed. The passage section identification unit 4 executes this processing for all of lines of sight stored in a line-of-sight information storage unit 2.

The passing line-of-sight information storage unit 9 stores the line-of-sight information and the grid ID information output from the passage section identification unit 4. At this time, it is preferable that the passing line-of-sight information storage unit 9 stores the line-of-sight information and the grid ID information so as to enable, on a per-grid basis, retrieval of the line-of-sight information of all of lines of sight that have passed through the grids.

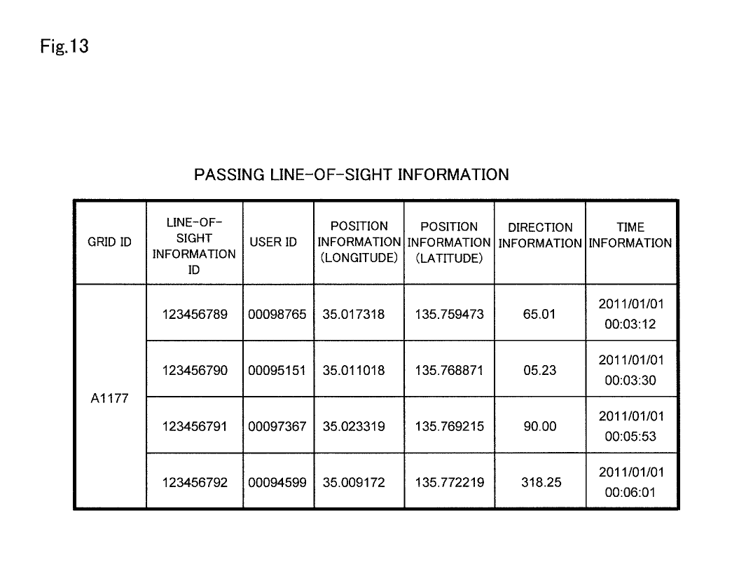

FIG. 13 shows examples of the line-of-sight information and the grid ID information stored in the passing line-of-sight information storage unit shown in FIG. 11. FIG. 13, which gives an example of a grid with a grid ID of A1177, shows the line-of-sight information of all of lines of sight that pass through this grid. The passing line-of-sight information storage unit 9 stores the line-of-sight information shown in FIG. 13 for all of grids stored in a grid information storage unit 3. The passing line-of-sight information storage unit 9 also outputs, to the interest degree calculation unit 62, the line-of-sight information stored therein showing the lines of sight that pass through the grids (hereinafter referred to as “passing line-of-sight information”).

In the present third embodiment, when the interest degree calculation unit 62 acquires the passing line-of-sight information of the grids output from the interest degree calculation unit 62, it sets, for each grid, pairs each consisting of two lines of sight by pairing all of the lines of sight that pass through the grid with one another based on the acquired passing line-of-sight information. Furthermore, the interest degree calculation unit 62 assigns a score to each of the set pairs based on a temporal relationship and a positional relationship between the two lines of sight, sums the scores of all of the pairs set for the grid, and uses the resultant sum total as an interest degree of the grid.

For example, the following hypothesis holds: “two lines of sight whose acquisition times are close to each other, and two lines of sight whose start points are positionally close to each other, have a high possibility of being acquired as a result of users gazing at the same object or place”. Under the above hypothesis, it is preferable that the interest degree calculation unit 62 adds a high score for the two lines of sight whose acquisition times are close to each other, and for the two lines of sight whose start points are positionally close to each other. More specifically, if scores are added under the above hypothesis, it is preferable that the interest degree calculation unit 62 calculates scores S using the following Expression 1 and assigns the calculated scores S to the pairs of lines of sight.

(Expression 1)

S=1/(α×β)

In the above Expression 1, a denotes a distance (km) between the start points of the two lines of sight (positions of users). β denotes a difference (min) between the acquisition times of the two lines of sight. According to the above Expression 1, the closer the positions of the start points of the two lines of sight to each other, and the closer the acquisition times of the two lines of sight to each other, the higher the assigned score S.

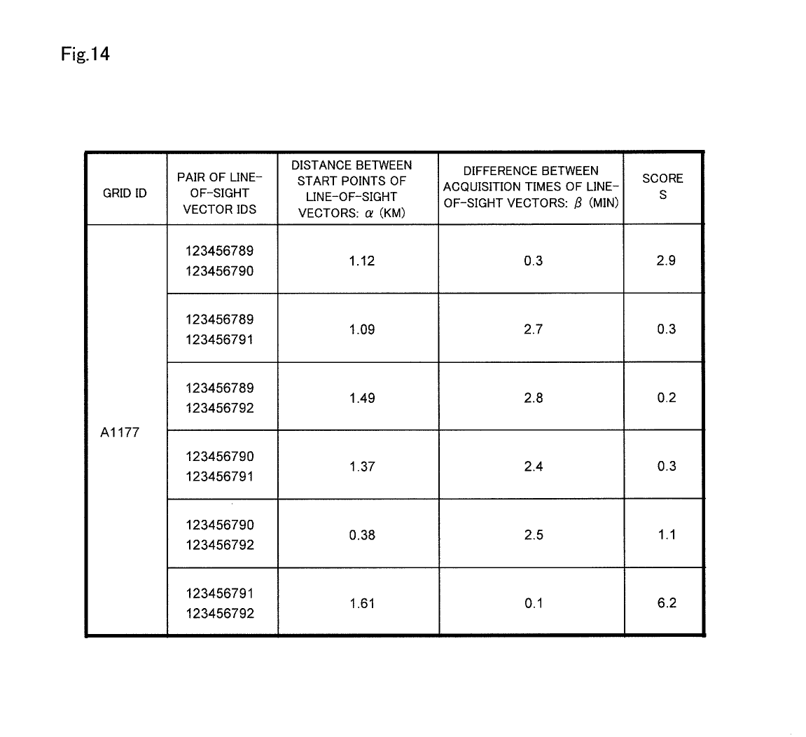

As one example, the following discusses scores assigned to the grid with the grid ID of A1177 shown in FIG. 13. As four lines of sight pass through the grid with the grid ID of A1177 as shown in FIG. 13, a total of six pairs are set for this grid. Therefore, the scores S are calculated for the six pairs based on the expressions shown in FIG. 14.

The resultant scores S calculated for the pairs are shown in FIG. 14. FIG. 14 shows examples of the scores calculated from the line-of-sight information shown in FIG. 13. It should be noted that, in FIG. 14, the distance a between the start points of the lines of sight is calculated from the “position information” shown in FIG. 13. On the other hand, the difference β between the acquisition times of the two lines of sight is calculated from the “time information” shown in FIG. 13.

By substituting α and β shown in FIG. 14 into the above Expression 1, the scores S shown in FIG. 14 are calculated. As described above, the scores S are assigned under the hypothesis that two lines of sight whose acquisition times are close to each other, and two lines of sight whose start points are positionally close to each other, have a high possibility of being lines of sight that were acquired as a result of users gazing at the same object or place.

Therefore, it can be considered that each score S shows a degree of a possibility that users 20 to which the corresponding lines of sight belong are both gazing at the grid A1177. Furthermore, it can be considered that the sum total of the scores S shows a degree of a possibility that the grid with the grid ID of A1177 is of interest to many users. In view of the above, a value of the interest degree of the grid with the grid ID of A1177, expressed as the sum total of the scores S, is “11”.

Once the sum totals of scores S or the interest degrees are calculated, a site of interest extraction unit 6 extracts a site of interest by, for example, comparing the interest degrees of grids with one another, similarly to the first and second embodiments. The site of interest extraction unit 6 also outputs information for identifying the extracted site of interest to a site of interest presentation unit 12 in a terminal 11.

In the terminal 11, for example, the site of interest presentation unit 12 applies coloring and the like to the extracted site of interest and displays the colored site of interest on a screen of a display device 13 as shown in FIG. 5 according to the first embodiment.

In the above-described example, the interest degree calculation unit 62 assigns a score to each of the set pairs such that the closer the acquisition times of the two lines of sight to each other, and the closer the start points of the two lines of sight to each other, the higher the score. However, the present third embodiment is not limited to this mode.

Alternatively, the following hypothesis also holds: two lines of sight that are close to each other in terms of direction have a high possibility of being acquired as a result of users 20 gazing at the same object or place. Therefore, under this hypothesis, an assigned score may increase as the angle formed by the two lines of sight decreases.

Furthermore, the following hypothesis also holds: an object or a place at which users 20 are gazing has a higher possibility of being located at a short distance than a possibility of being located at a far distance. Therefore, under this hypothesis, an assigned score may increase as a distance from a start point of a line of sight to a grid through which the line of sight passes decreases.

In addition, if the line-of-sight information includes information for identifying the altitudes of the positions of the users 20, scores may be assigned based on the altitudes. For example, the following hypothesis holds: a site higher than its surroundings can be viewed well from a low site, and a site lower than its surroundings can be viewed well from a high site. Therefore, under this hypothesis, an average altitude of each grid through which lines of sight pass may be compared with an average altitude of a grid in which a user is located, and an assigned score may increase as the difference between these average altitudes increases.

Apparatus Operations

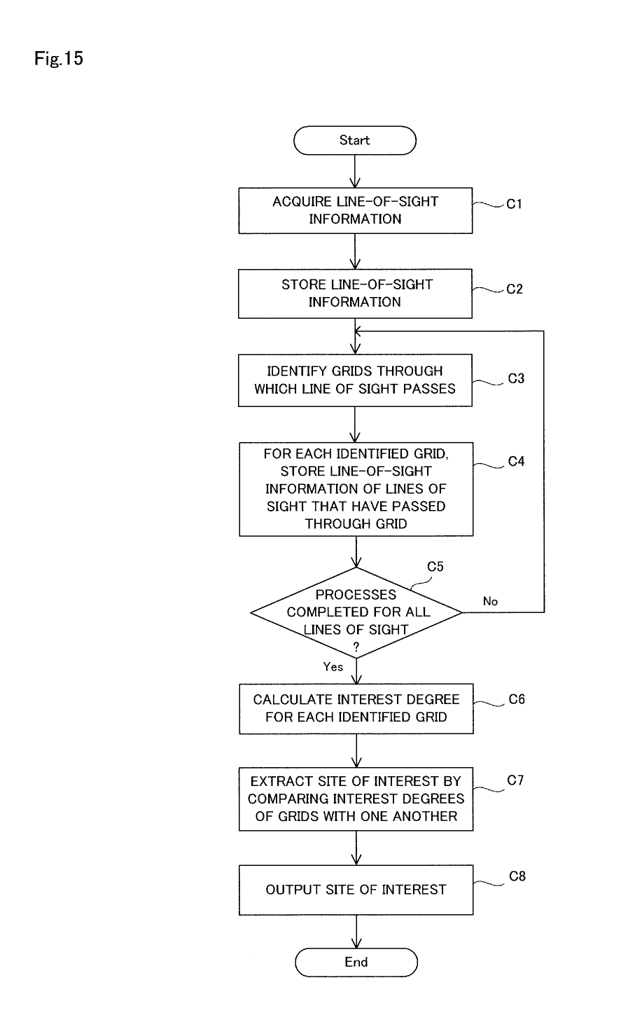

The operations of the site of interest extraction apparatus 60 according to the third embodiment of the present invention will now be described with reference to FIG. 15. FIG. 15 is a flow diagram showing the operations of the site of interest extraction apparatus according to the third embodiment of the present invention. In the following description, FIGS. 11 to 14 will be referred to where appropriate. In the present third embodiment, the site of interest extraction method is implemented by causing the site of interest extraction apparatus 60 to operate. Therefore, the following description of the operations of the site of interest extraction apparatus 60 applies to the site of interest extraction method according to the present third embodiment.

First, as shown in FIG. 15, in the site of interest extraction apparatus 60, a line-of-sight information acquisition unit 1 acquires position information and direction information from terminal devices (communication terminals) 21 of users 20, and outputs the acquired position information and direction information to the line-of-sight information storage unit 2 (step C1). Next, the line-of-sight information storage unit 2 stores the position information and the direction information output from the line-of-sight information acquisition unit 1 as line-of-sight information (step C2). Thereafter, with the use of the line-of-sight information stored in the line-of-sight information storage unit 2 and grid information stored in the grid information storage unit 3, the passage section identification unit 4 renders a line of sight of each user 20 on a map of a specific area in which grids are set, and identifies grids through which the line of sight passes (step C3). Steps C1 to C3 are similar to steps A1 to A3 shown in FIG. 6.

Next, once the passage section identification unit 4 identifies the grids through which the line of sight has passed, it outputs, for each of the identified grids, the line-of-sight information of the line of sight that has passed through the grid to the passing line-of-sight information storage unit 9, and causes the same to store the output line-of-sight information (step C4). More specifically, the passage section identification unit 4 outputs, to the passing line-of-sight information storage unit 9, the line-of-sight information of the line of sight that has passed and the grid ID information of all of the grids through which the line of sight has passed. The passing line-of-sight information storage unit 9 stores the output information. It is preferable that the passing line-of-sight information storage unit 9 stores the line-of-sight information and the grid ID information so as to enable, for each grid, retrieval of the line-of-sight information of all of lines of sight that have passed through the grid.

Upon completion of step C4, the interest degree calculation unit 5 determines whether or not steps C3 and C4 have been completed for all lines of sight (step C5). If the result of determination in step C5 shows that steps C3 and C4 have not been completed for all lines of sight, step C3 is executed again. On the other hand, if the result of determination in step C5 shows that steps C3 and C4 have been completed for all lines of sight, step C5 is executed.

Thereafter, in step C5, the interest degree calculation unit 62 calculates interest degrees of the grids using the passing line-of-sight information of the grids stored in the passing line-of-sight information storage unit 9 (step C5). More specifically, the interest degree calculation unit 62 sets, for each grid, pairs each consisting of two lines of sight by pairing all of the lines of sight that pass through the grid with one another based on the passing line-of-sight information of the grid. Furthermore, the interest degree calculation unit 62 assigns a score to each of the set pairs based on a temporal relationship and a positional relationship between the two lines of sight, sums the scores of all of the pairs set for the grid, and uses the resultant sum total as an interest degree of the grid.

Next, the site of interest extraction unit 6 compares the interest degrees that the interest degree calculation unit 5 calculated on a per-grid basis, and extracts a grid with a high interest degree as a site of interest (step C6). Subsequently, the site of interest extraction unit 6 outputs the extracted site of interest to the terminal 11 (step C7). Steps C6 and C7 are similar to steps A6 and A7 shown in FIG. 6. Consequently, the site of interest presentation unit 12 displays the site of interest extracted by the site of interest extraction unit 6 on a display screen of the display device 13, thereby presenting the same to a service customer 22.

Program

It is sufficient for the program according to the present third embodiment to cause a computer to execute steps C1 to C7 shown in FIG. 15. The site of interest extraction apparatus 60 and the site of interest extraction method according to the present third embodiment can be realized by installing this program in the computer and executing the installed program. In this case, a CPU (central processing unit) of the computer functions as the line-of-sight information acquisition unit 1, the passage section identification unit 4, the interest degree calculation unit 62 and the site of interest extraction unit 6, and executes processing accordingly. Also, a storage device provided for the computer, such as a hard disk drive, functions as the line-of-sight information storage unit 2, the grid information storage unit 3 and the passing line of sight storage unit 61.

Furthermore, in the present third embodiment also, the line-of-sight information storage unit 2, the grid information storage unit 3 and the passing line of sight storage unit 61 may be realized by a computer different from the computer in which the program according to the present third embodiment is installed, similarly to the first embodiment. In this case, the computer in which the program according to the present third embodiment is installed is connected to the computer realizing the line-of-sight information storage unit 2, the grid information storage unit 3 and the passing line of sight storage unit 61 via a network and the like.

Moreover, in the case where a communication terminal, such as a mobile telephone and a smartphone, has a function of executing programs, the program according to the present third embodiment may be installed in the communication terminal. In this case, a CPU of the communication terminal functions as the line-of-sight information acquisition unit 1, the passage section identification unit 4, the interest degree calculation unit 62 and the site of interest extraction unit 6, and the site of interest extraction apparatus 50 is configured inside the communication terminal. In this mode, the site of interest presentation unit 12 may be configured inside the communication terminal as well.

It should be noted that, even if the communication terminal functions as the site of interest extraction apparatus 60, it is preferable that the line-of-sight information acquisition unit 1 and the line-of-sight information storage unit 2 are configured by a server computer different from the communication terminal. While the terminal devices 21 of the users 20 are described as communication terminals equipped with GPS modules and electronic compasses in the above example, the terminal devices 21 are not limited to being communication terminals in the present third embodiment, similarly to the first embodiment. It is sufficient for the terminal devices 21 to be devices that can acquire the position information and the direction information in an inexpensive manner without using a large-scale configuration, and that do not require operations that lay a burden on the users 20.

Also, in the above example, once the service customer 22 requests the extraction of a site of interest, the interest degrees are calculated by executing steps C1 to C7 using all of the line-of-sight information stored in the line-of-sight information storage unit 2. However, the present third embodiment is not limited to this mode.

For example, similarly to the first embodiment, the present third embodiment may also adopt a mode in which, prior to the request for the extraction of the site of interest, the site of interest extraction apparatus 60 calculates the interest degrees in advance on a per-grid basis using the line-of-sight information stored in the line-of-sight information storage unit 2, and compares the interest degrees of the grids with one another. In this mode, it is preferable that the site of interest extraction apparatus 60 includes a storage unit for storing the interest degrees calculated in advance and the result of comparison between the interest degrees.

If this mode is adopted, once the service customer 22 requests the extraction of the site of interest, the site of interest extraction apparatus 60 can immediately acquire information related to the interest degrees by accessing the storage unit, and therefore the customer 22 can promptly receive information related to the site of interest.

### Effects of Third Embodiment

As described above, according to the present third embodiment, a high score can be assigned to a grid that is considered to be of interest to many users with higher accuracy, thus enabling the extraction of a more accurate site of interest. Furthermore, the effects described in the first embodiment can be achieved also in the present third embodiment. Moreover, in the present third embodiment, the configurations described in the second embodiment can further be combined. In this case, the effects described in the second embodiment can also be achieved.

(Configuration of Computer)

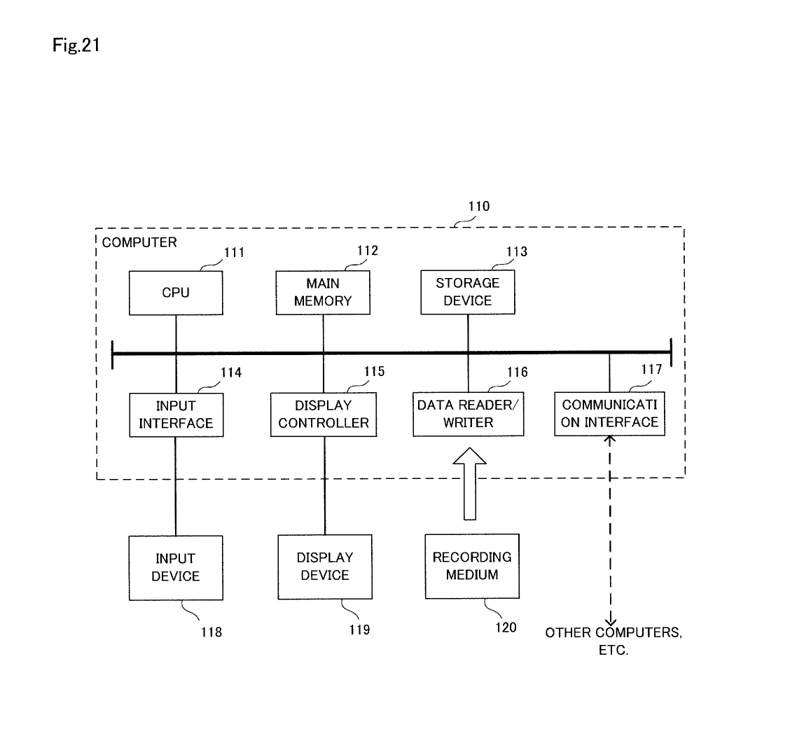

A description is now given of a computer that realizes the site of interest extraction apparatuses by executing the programs according to the first to third embodiments with reference to FIG. 21. FIG. 21 is a block diagram showing one example of a computer that realizes the site of interest extraction apparatuses according to the first to third embodiments of the present invention.

As shown in FIG. 21, a computer 110 includes a CPU 111, a main memory 112, a storage device 113, an input interface 114, a display controller 115, a data reader/writer 116, and a communication interface 117. These components are connected in such a manner that they can perform data communication with one another via a bus 121.

The CPU 111 executes various types of operations by deploying programs (codes) according to the embodiments stored in the storage device 113 to the main memory 112, and executing the deployed programs in a predetermined order. The main memory 112 is typically a volatile storage device such as a DRAM (dynamic random-access memory). The programs according to the embodiments are provided while being stored in a computer-readable recording medium 120. Alternatively, the programs according to the embodiments may be distributed over the Internet connected via the communication interface 117.

Specific examples of the storage device 113 include a hard disk drive and a semiconductor storage device such as a flash memory. The input interface 114 mediates data transmission between the CPU 111 and an input device 118 such as a keyboard and a mouse. The display controller 115 is connected to a display device 119 and controls display on the display device 119. The data reader/writer 116 mediates data transmission between the CPU 111 and the recording medium 120. Specifically, the data reader/writer 116 reads the programs from the recording medium 120, and writes the result of processing in the computer 110 into the recording medium 120. The communication interface 117 mediates data transmission between the CPU 111 and other computers.

Specific examples of the recording medium 120 include a genera-purpose semiconductor storage device such as a CF (CompactFlash, registered trademark) and an SD (Secure Digital), a magnetic storage medium such as a flexible disk, and an optical storage medium such as a CD-ROM (Compact Disc read-only memory).

### First Working Example

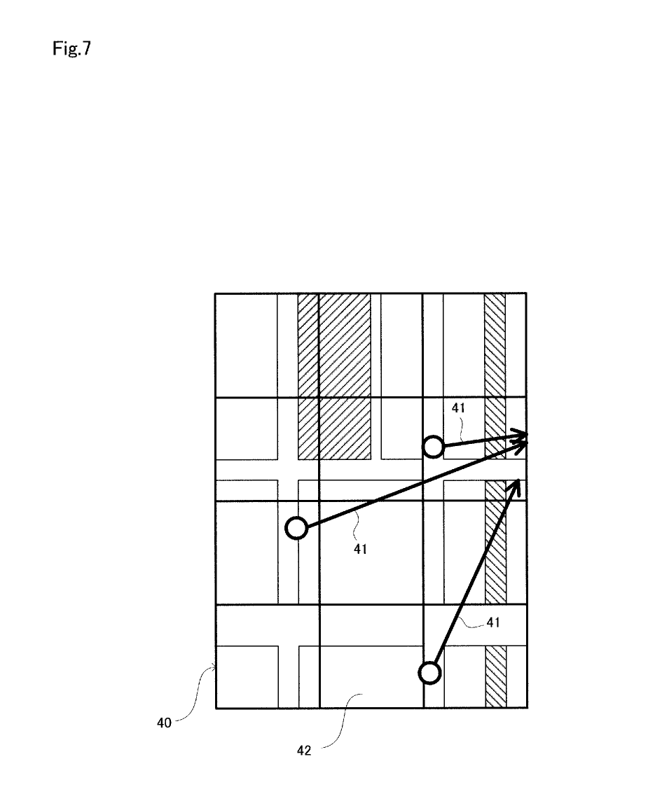

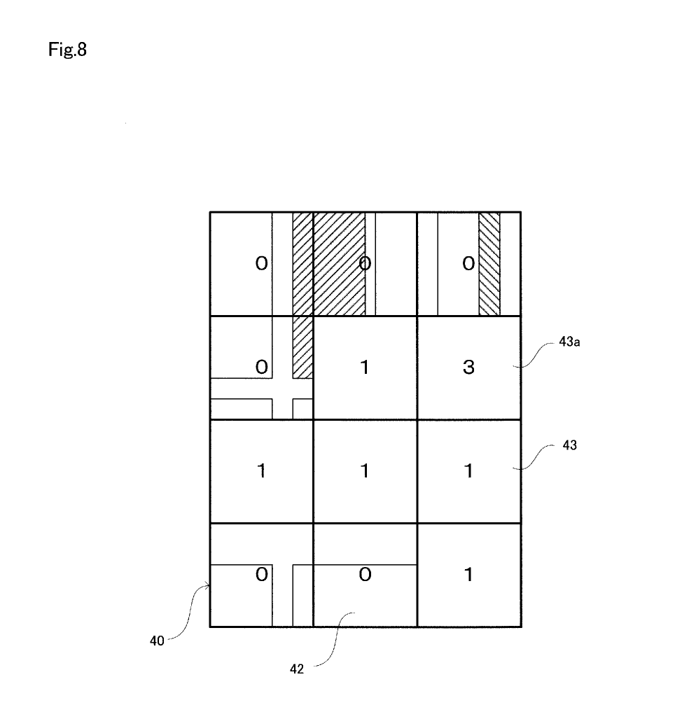

A first working example of the present invention will now be described in detail with reference to FIGS. 7 and 8. The present first working example corresponds to the first embodiment described above. In the following description, FIGS. 1 to 6 will be referred to where appropriate.

In the present first working example, terminal devices 21 of users 20 are mobile telephones equipped with GPS modules and electronic compasses. Furthermore, a site of interest extraction apparatus 10 is configured by a program inside a server computer. Moreover, a site of interest presentation unit 12 is configured in a computer terminal operated by a customer 22 who seeks to extract a site of interest. In the present first working example, when the customer 22 communicates with the external site of interest extraction apparatus 10 by operating the computer terminal, the extracted site of interest is displayed on a display device 13 of the computer terminal.

First, in the present first working example, position information and direction information, that is to say, line-of-sight information of the users is acquired by the terminal devices 21 (mobile telephones) owned by the users 20. More specifically, the users face the directions at which they are gazing while holding their mobile telephones in hand, and execute an operation for transmitting the line-of-sight information. In this way, the GPS modules and the electronic compasses are activated, and lines of sight of the users are acquired.

In the case where the mobile telephones are equipped with acceleration sensors, the line-of-sight information can be acquired by causing the users 20 to carry their mobile telephone terminals at a specified position. More specifically, if the mobile telephones detect that values of the acceleration sensors have not changed for at least a designated time period, such as 10 seconds, the mobile telephones are caused to activate the GPS modules and the electronic compasses and to acquire the position information and the direction information. This reduces the effort experienced by the users 20.

Alternatively, in the case where the users 20 capture photographs using the mobile telephones and execute, for example, an operation for selecting an object displayed on screens via an AR (augmented reality) service provided using camera images and the like, the mobile telephones may be caused to activate the GPS modules and the electronic compasses and to acquire the position information and the direction information.

The line-of-sight information and the direction information acquired by the mobile telephones of many users 20 are transmitted to the server computer inside which the site of interest extraction apparatus 10 is configured via a mobile telephone communication network, and stored in a line-of-sight information storage unit 2 by a line-of-sight information acquisition unit 1.

The line-of-sight information storage unit 2 stores the line-of-sight information collected from the mobile telephones of the plurality of users 20. In the present first working example, it is assumed that the line-of-sight information stored in the line-of-sight information storage unit 2 is the line-of-sight information according to the first embodiment shown in FIG. 2.

As has already been described, in the line-of-sight information shown in FIG. 2, the positions (directions and latitudes) of the mobile telephones and the directions of the users 20 are associated with time information of acquisition times of the position information and the direction information, and with user IDs of the users from which the line-of-sight information was acquired. Furthermore, line-of-sight information IDs are also assigned to the line-of-sight information so as to distinguish the line-of-sight information in relation to the above information, and stored in the line-of-sight information storage unit 2 as a part of the line-of-sight information.

As shown in FIG. 3, a grid information storage unit 3 stores map information and grid information, together with information for identifying a grid ID, the size, and the position of each grid. The grid information storage unit 3 further outputs the above information to a passage section identification unit 4. Also, in the present first working example, each grid is set to have a square shape as shown in FIG. 3. Such square grids are effective when a site of interest to be extracted is, for example, a building or scenery.

Furthermore, in the present first working example, the length of each side of the grids can be arbitrarily selected from among 500 m, 1 km, and so on, by a provider of a site of interest extraction service or by the service customer 22, depending on the scale of the site of interest to be extracted. Furthermore, the provider of the site of interest extraction service and the service customer can arbitrarily select the shape of the grids.

The passage section identification unit 4 composites the lines of sight and the grids using the line-of-sight information provided from the line-of-sight information storage unit 2 and the grid information provided from the grid information storage unit 3, and identifies grids through which the lines of sight have passed. The passage section identification unit 4 also notifies an interest degree calculation unit 5 of the grid IDs of the identified grids.

The interest degree calculation unit 5 adds a certain score for all of the grids through which the lines of sight have passed. For example, in the present first working example also, the interest degree calculation unit 5 adds a score for all of the grids through which the acquired lines of sight pass, as shown in FIG. 4. In this way, for all of lines of sight stored in the line-of-sight information storage unit 2, a score is added for grids through which they have passed. Once the addition is completed, a grid through which a larger number of lines of sight pass has a higher total score, hence a higher interest degree.

It will be assumed that the line-of-sight information stored in the line-of-sight information storage unit 1 includes three lines of sight 41 as shown in FIG. 7. FIG. 7 shows examples of lines of sight acquired in the first working example of the present invention.

In the present first working example, it is assumed that the interest degree calculation unit 5 adds “one point” for grids 43 through which any line of sight 41 passes as an interest degree. In this case, the result of addition for the grids through which the three lines of sight 41 shown in FIG. 7 pass, that is to say, the interest degrees of the grids are as shown in FIG. 8. FIG. 8 shows the result of calculation of the interest degrees in the first working example of the present invention. Subsequently, in the present first working example, the interest degree calculation unit 5 outputs, to a site of interest extraction unit 6, pair data in which the calculated interest degrees of the grids are paired with the grid IDs.

Using the pair data including the grid IDs and the interest degrees output from the interest degree calculation unit 5, the site of interest extraction unit 6 compares the magnitudes of the interest degrees of the grids with one another, rearranges the grids in order of highest interest degree, and extracts grids in order of rearrangement. Alternatively, the site of interest extraction unit 6 may extract only grids of set ranks in order of highest interest degree.

In the present first working example, it is assumed that, after the site of interest extraction unit 6 has rearranged the grids in order of highest interest degree, one grid 43a with the highest interest degree is selected. Provided that the result acquired from the interest degree calculation unit 5 is as shown in FIG. 8, in view of FIG. 3, the grid 43a with the highest interest degree is a grid with the grid ID of A1175. In this case, the site of interest extraction unit 6 outputs the acquired grid ID (=A1175) to a terminal 11 of the customer 22.

In the terminal 11 of the customer 22, the site of interest presentation unit 12 displays the site of interest (grid) provided from the site of interest extraction unit 6 on a display screen of the display device 13 of the terminal 11. More specifically, in the present first working example, as shown in FIG. 5, the site of interest presentation unit 12 displays, on the screen of the display device 13, a screen displaying a grid that has the highest interest degree on a map (in FIG. 5, a grid 44) in a colored fashion. It can be said that this grid 44 displayed in a colored fashion, as shown in FIG. 5, is a place at which many users were gazing, that is to say, a site of interest to many users.

### Effects of First Working Example

As described above, in the present first working example, a site at which many people are gazing is extracted using only two pieces of information, that is to say, the position information and the direction information collected from many people. Furthermore, the position information and the direction information can be acquired in an inexpensive and easy manner compared to distance information. Therefore, in the present first working example, a site of interest to many people can be extracted in an inexpensive and easy manner.

### Second Working Example

A second working example of the present invention will now be described in detail. The present second working example corresponds to the second embodiment described above. In the following description, FIGS. 9 and 10 will be referred to where appropriate.

In the present second working example also, terminal devices 21 of users 20 are mobile telephones equipped with GPS modules and electronic compasses similarly to the first working example. Furthermore, a site of interest extraction apparatus 50 is configured by a program inside a server computer. Moreover, a site of interest presentation unit 12 and a condition setting unit 14 are configured in a computer terminal operated by a customer 22 who seeks to extract a site of interest. In the present second working example also, when the customer 22 communicates with the external site of interest extraction apparatus 50 by operating the computer terminal, the extracted site of interest is displayed on a display device 13 of the computer terminal. The following description will be given mainly with a focus on differences from the first working example.

First, in the present second working example, the customer 22 inputs a set condition for identifying passage grids via the condition setting unit 14 in accordance with the purpose of use. For example, assume the case where the customer 22 wishes to extract a site of interest using line-of-sight information acquired between 00:00:00 of Jan. 1, 2011 and 00:05:00 of Jan. 1, 2011. In this case, the customer 22 inputs “00:00:00 of Jan. 1, 2011 to 00:05:00 of Jan. 1, 2011” as the set condition to the computer terminal including the condition setting unit 14.

Next, provided that line-of-sight information stored in a line-of-sight information storage unit 2 is the line-of-sight information shown in FIG. 2, a passage section identification unit 51 compares the set condition with the time information shown in FIG. 2, and identifies a line of sight with the line-of-sight information ID of 12345689 and a line of sight with the line-of-sight information ID of 123456790. The passage section identification unit 51 identifies passage grids for the identified lines of sight. On the other hand, the passage section identification unit 51 does not identify passage grids for a line of sight with the line-of-sight ID of 123456791 and a line of sight with the line-of-sight ID of 123456792.

Furthermore, the passage section identification unit 51 provides an interest degree calculation unit 5 with grid IDs of the grids through which the lines of sight satisfying the set condition have passed as a result of identification of the passage grids. Thereafter, similarly to the first working example, the interest degree calculation unit 5 and a site of interest extraction unit 6 operate, and ultimately the site of interest is displayed on a display screen of the display device 13 in a terminal 11 of the customer 22. It can be said that this site of interest was a site of interest to the largest number of people between 00:00:00 of Jan. 1, 2011 and 00:05:00 of Jan. 1, 2011.

### Effects of Second Working Example

As described above, in the present second working example, grids through which lines of sight pass are identified based on a set condition. Therefore, the present second working example enables elimination of lines of sight, grids, and the like that are unnecessary for the customer. Consequently, the customer can reliably acquire site-of-interest information needed.

### Third Working Example

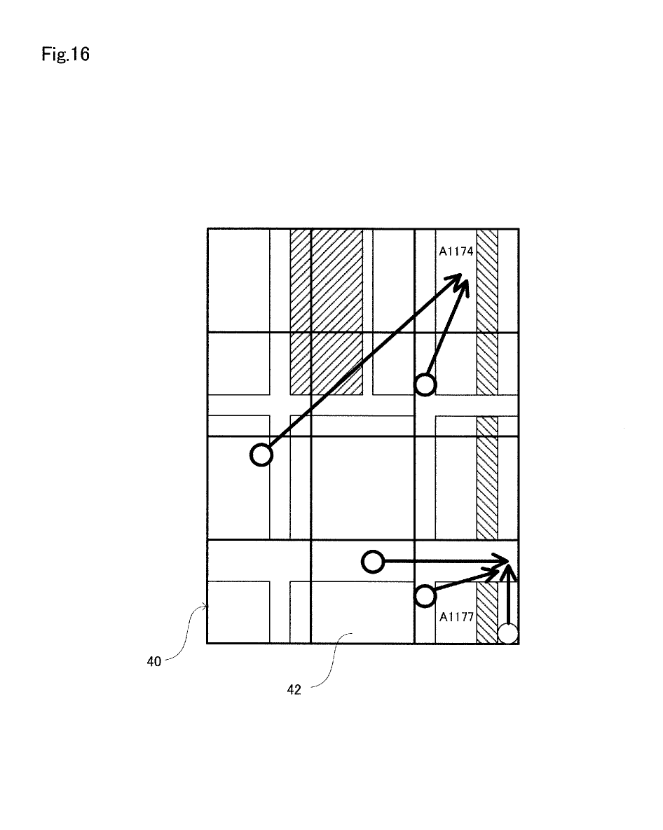

A third working example of the present invention will now be described in detail with reference to FIGS. 16 to 20. The present third working example corresponds to the third embodiment described above. In the following description, FIGS. 11 to 15 will be referred to where appropriate.

In the present third working example also, terminal devices 21 of users 20 are mobile telephones equipped with GPS modules and electronic compasses similarly to the first working example. Furthermore, a site of interest extraction apparatus 60 is configured by a program inside a server computer. Moreover, a site of interest presentation unit 12 is configured in a computer terminal operated by a customer 22 who seeks to extract a site of interest. In the present third working example also, when the customer 22 communicates with the external site of interest extraction apparatus 60 by operating the computer terminal, the extracted site of interest is displayed on a display device 13 of the computer terminal. The following description will be given mainly with a focus on differences from the first working example.

For the sake of explanation, examples of sites at which the users are actually gazing, instead of acquired line-of-sight information, are shown in FIG. 16. FIG. 16 shows examples of sites at which the users are actually gazing in the third working example of the present invention. According to the examples shown in FIG. 16, there are five users 20, two of whom are gazing at a grid with the grid ID of A1174, and three of whom are gazing at a grid with the grid ID of A1177.

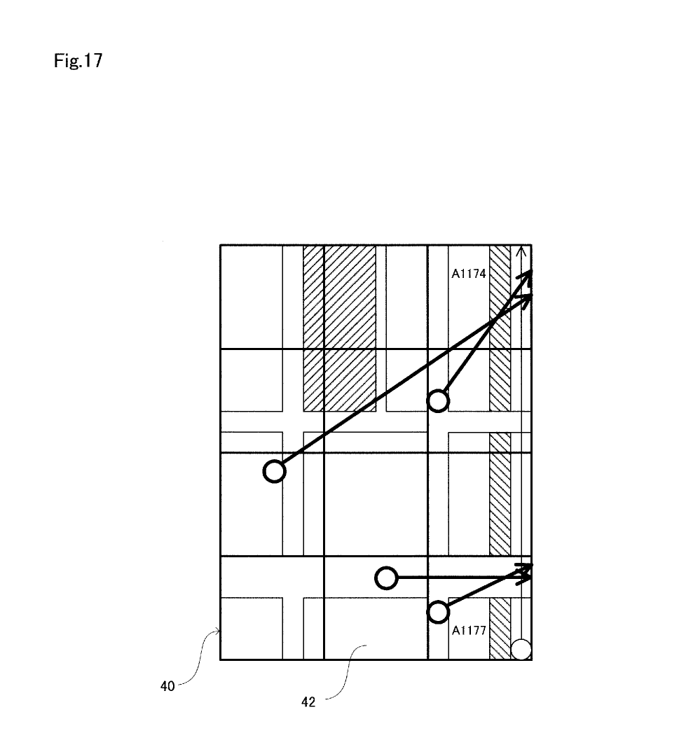

According to the examples shown in FIG. 16, a site of interest to the largest number of users is the grid with the grid ID of A1177. However, line-of-sight information includes position information and direction information of the users, but does not include distance information of distances to sites at which the users are gazing. In addition, acquisition of the distance information is difficult as mentioned in the Technical Problem section. Therefore, presenting five lines of sight 41 acquired from the users 20 on a map in the state of FIG. 16 results in the state of FIG. 17. In the case of FIG. 17, a site of interest to the largest number of users is the grid with the grid ID of A1174. FIG. 17 shows examples of the lines of sight acquired in the third working example of the present invention.

In the following description of the present third working example, it is assumed that line-of-sight information stored in a line-of-sight information storage unit 2 pertains to the five lines of sight shown in FIG. 17. Furthermore, a description of calculation of interest degrees will be given with a focus only on the grids A1174 and A1177 through which the largest number of lines of sight pass, and other grids are omitted therefrom.

In the present third working example, similarly to the first and second working examples, a passage section identification unit 4 composites the lines of sight and the grids using the line-of-sight information provided from the line-of-sight information storage unit 2 and grid information provided from a grid information storage unit 3, and identifies grids through which the lines of sight have passed. Then, in the present third working example, the passage section identification unit 4 outputs, for each line of sight, the line-of-sight information of the line of sight and information for identifying all of grids through which the line of sight passes (grid ID information) to a passing line-of-sight information storage unit 9. This processing is executed for all of lines of sight stored in the line-of-sight information storage unit 2.

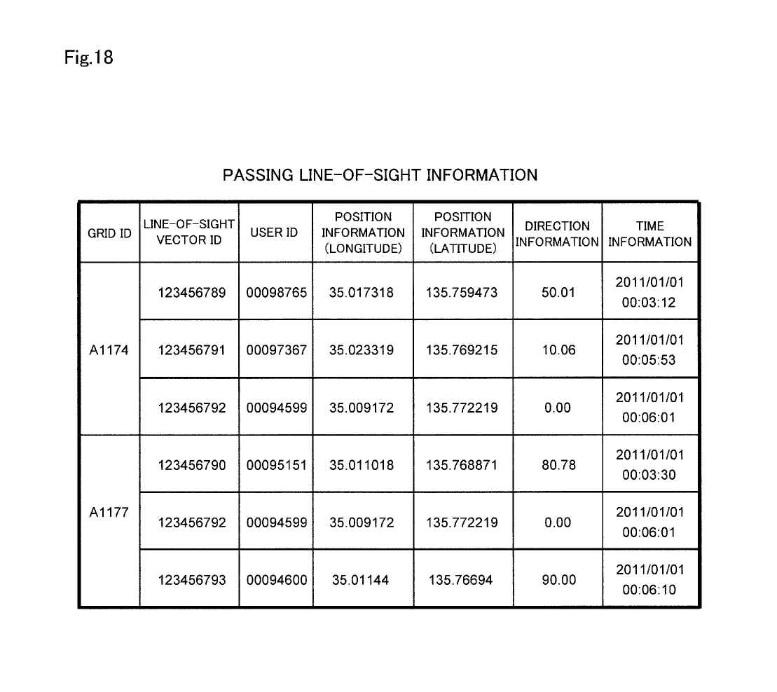

The passing line-of-sight information storage unit 9 stores the line-of-sight information and the grid ID information output from the passage section identification unit 4. FIG. 18 shows examples of the line-of-sight information and the grid ID information stored in the passing line-of-sight information storage unit in the present third working example. As shown in FIG. 18, the passing line-of-sight information storage unit 9 stores, on a per-grid basis, the line-of-sight information of lines of sight that pass through grids (passing line-of-sight information). The passing line-of-sight information storage unit 9 also outputs the stored passing line-of-sight information of the grids to an interest degree calculation unit 62. Using the passing line-of-sight information provided from the passing line-of-sight information storage unit 9, the interest degree calculation unit 62 calculates interest degrees on a per-grid basis. In the present third working example, first, calculation of an interest degree of the grid with the grid ID of A1174 shown in FIG. 18 will be discussed.

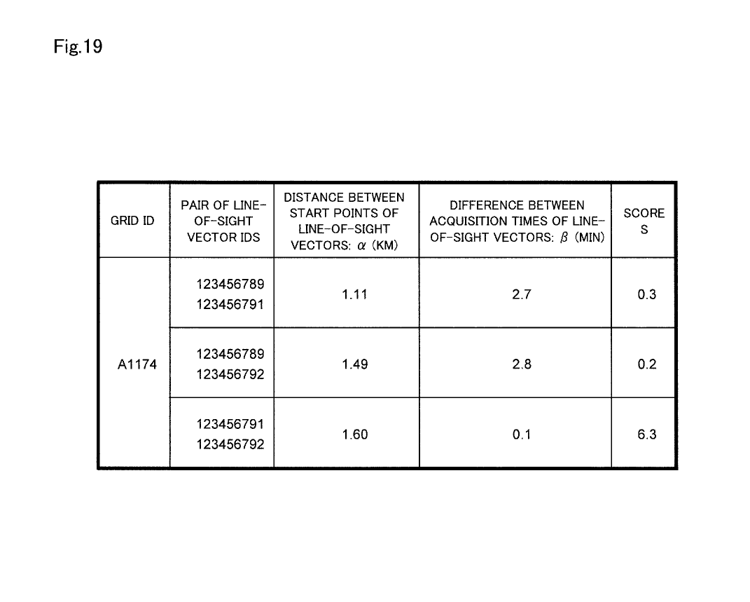

The interest degree calculation unit 62 sets pairs by selecting two of the three lines of sight that pass through the grid A1174. Thereafter, for each pair, the interest degree calculation unit 62 acquires a distance (km) between start points of the two lines of sight and a difference (minutes) between acquisition times of the two lines of sight from the position information and the time information shown in FIG. 18, and then calculates a score S using the above Expression 1. The result is as shown in FIG. 19. FIG. 19 shows one example of interest degree calculation processing according to the third working example. According to the result shown in FIG. 19, the calculated interest degree of the grid A1174, i.e. a sum total of the scores S, is “6.8”.

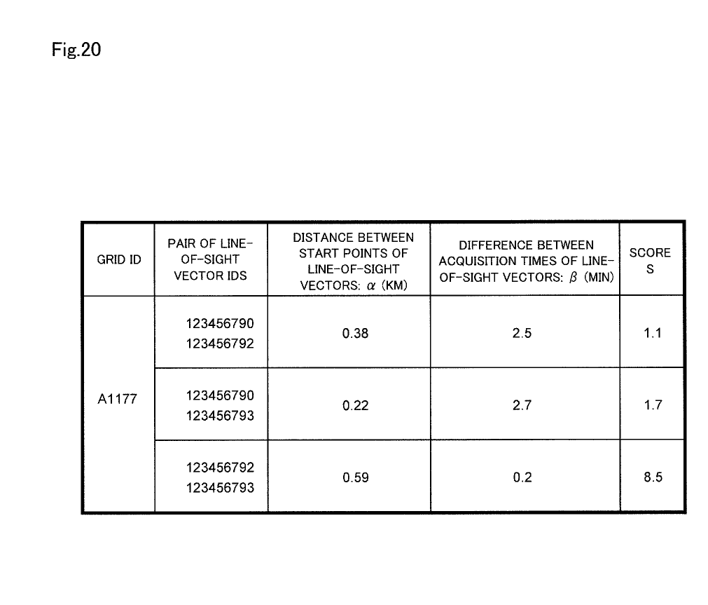

Similarly, calculation of an interest degree of the grid with the grid ID of A1177 shown in FIG. 18 will now be discussed. In this case also, the interest degree calculation unit 62 sets pairs by selecting two of the three lines of sight that pass through the grid A1177. Thereafter, for each pair, the interest degree calculation unit 62 acquires a distance (km) between start points of the two lines of sight and a difference (minutes) between acquisition times of the two lines of sight from the position information and the time information shown in FIG. 18, and then calculates a score S using the above Expression 1. The result is as shown in FIG. 20. FIG. 20 shows another example of the interest degree calculation processing according to the third working example. According to the result shown in FIG. 20, the calculated interest degree of the grid A1177, i.e. a sum total of the scores S, is “11.3”. The interest degrees of the grids acquired through the above processing are output to a site of interest extraction unit 6.

The site of interest extraction unit 6 compares the grids with one another based on the interest degrees of the grids output from the interest degree calculation unit 10, rearranges the grids in order of highest interest degree based on the result of comparison, and extracts grids in order of rearrangement. Alternatively, the site of interest extraction unit 6 may extract only grids of set ranks in order of highest interest degree.

Specifically, in the present third working example, the site of interest extraction unit 6 extracts a grid with the highest interest degree as a site of interest. As the interest degrees of the grids A1174 and A1177 are “6.8” and “11.3”, respectively, the site of interest extraction unit 6 extracts the grid A1177 with the largest interest degree as a site of interest. The site of interest extraction unit 6 accordingly outputs the grid ID of the site of interest A1177) to a terminal 11 of the customer 22. In the terminal 11 of the customer 22, the site of interest presentation unit 12 displays the site of interest (grid) provided from the site of interest extraction unit 6 on a display screen of the display device 13 of the terminal 11. More specifically, in the present third working example, the site of interest presentation unit 12 displays, on the screen of the display device 13, a screen displaying the grid A1177 in a colored fashion.

### Effects of Third Working Example

As described above, according to the present third working example, a high score can be assigned to a grid that is considered to be of interest to many users with higher accuracy, thus enabling the extraction of a more accurate site of interest. More specifically, as the line-of-sight information acquired from the users does not include distance information, there are cases where it is difficult to determine which grid represents a site of interest to more users, as shown in the examples of FIGS. 16 and 17. Even in such cases, the present third working example enables the extraction of a site of interest with higher accuracy using information such as acquisition times of lines of sight and the positions of start points of the lines of sight.

A part or all of the above embodiments can be described as, but are not limited to, the following Supplementary notes 1 to 24.

### (Supplementary Note 1)

A site of interest extraction apparatus for extracting a site of interest to a plurality of users, including: a passage section identification unit that, for each user, renders a virtual line on a map of a specific area using position information and direction information based on map information of the specific area and on grid information identifying a plurality of sections set in the area, and identifies sections through which the virtual line passes, the position information and the direction information being acquired for each user from a device owned by the user and identifying a position of the user and a direction in which the user is facing, respectively, and the virtual line being defined by the position information and the direction information; an interest degree calculation unit that, for each identified section, adds a score in accordance with the virtual lines passing through the section, and calculates the added score as an interest degree; and a site of interest extraction unit that selects one of the identified sections based on the calculated interest degrees, and extracts the selected section as a site of interest to the plurality of users.

### (Supplementary Note 2)

The site of interest extraction apparatus according to Supplementary note 1, wherein the site of interest extraction unit displays the extracted site of interest to the plurality of users on a screen of an external display device.

### (Supplementary Note 3)

The site of interest extraction apparatus according to Supplementary note 1 or 2, wherein the site of interest extraction unit selects a section for which the highest interest degree has been calculated.

### (Supplementary Note 4)

The site of interest extraction apparatus according to Supplementary note 2 or 3, wherein the passage section identification unit renders the virtual lines from start points to set end points in directions identified by the direction information, the start points being positions identified by the position information.

### (Supplementary Note 5)

The site of interest extraction apparatus according to any one of Supplementary notes 1 to 4, wherein the passage section identification unit identifies the sections through which the virtual lines pass based on a preset condition.

### (Supplementary Note 6)

The site of interest extraction apparatus according to Supplementary note 5, wherein the preset condition is externally set and includes at least one of a restriction on the virtual lines according to a time frame during which the position information and the direction information are acquired, a restriction on the virtual lines according to sections of passage, and a restriction on a part of the plurality of users.

### (Supplementary Note 7)

The site of interest extraction apparatus according to any one of Supplementary notes 1 to 6, wherein the interest degree calculation unit adds the score for each identified section such that the larger the number of the virtual lines passing through the section, the higher the score.

### (Supplementary Note 8)

The site of interest extraction apparatus according to any one of Supplementary notes 1 to 6, wherein for each identified section, the interest degree calculation unit sets pairs each consisting of two virtual lines by pairing all of the virtual lines passing through the section with one another, assigns a score to each pair based on a temporal relationship and on a positional relationship between the two virtual lines, sums the scores of all of the pairs set for the section, and uses a resultant sum total as the interest degree of the section.

### (Supplementary Note 9)

A site of interest extraction method for extracting a site of interest to a plurality of users, including: (a) a step of, for each user, rendering a virtual line on a map of a specific area using position information and direction information based on map information of the specific area and on grid information identifying a plurality of sections set in the area, and identifying sections through which the virtual line passes, the position information and the direction information being acquired for each user from a device owned by the user and identifying a position of the user and a direction in which the user is facing, respectively, and the virtual line being defined by the position information and the direction information; (b) a step of, for each identified section, adding a score in accordance with the virtual lines passing through the section, and calculating the added score as an interest degree; and (c) a step of selecting one of the identified sections based on the calculated interest degrees, and extracting the selected section as a site of interest to the plurality of users.

### (Supplementary Note 10)

The site of interest extraction method according to Supplementary note 9, further including (d) a step of displaying the site of interest to the plurality of users extracted in step (c) on a screen of an external display device.

### (Supplementary Note 11)

The site of interest extraction method according to Supplementary note 9 or 10, wherein in step (c), a section for which the highest interest degree has been calculated is selected.

### (Supplementary Note 12)

The site of interest extraction method according to Supplementary note 10 or 11, wherein in step (a), the virtual lines are rendered from start points to set end points in directions identified by the direction information, the start points being positions identified by the position information.

### (Supplementary Note 13)

The site of interest extraction method according to any one of Supplementary notes 9 to 12, wherein in step (a), the sections through which the virtual lines pass are identified based on a preset condition.

### (Supplementary Note 14)

The site of interest extraction method according to Supplementary note 13, wherein the preset condition in step (a) is externally set and includes at least one of a restriction on the virtual lines according to a time frame during which the position information and the direction information are acquired, a restriction on the virtual lines according to sections of passage, and a restriction on a part of the plurality of users.

### (Supplementary Note 15)

The site of interest extraction method according to any one of Supplementary notes 9 to 14, wherein in step (b), the score is added for each identified section such that the larger the number of the virtual lines passing through the section, the higher the score.

### (Supplementary Note 16)

The site of interest extraction method according to any one of Supplementary notes 9 to 14, wherein in step (b), for each identified section, pairs each consisting of two virtual lines are set by pairing all of the virtual lines passing through the section with one another, a score is assigned to each pair based on a temporal relationship and on a positional relationship between the two virtual lines, the scores of all of the pairs set for the section are summed, and a resultant sum total is used as the interest degree of the section.

### (Supplementary Note 17)

A computer-readable recording medium having recorded therein a program for extracting a site of interest to a plurality of users using a computer, the program including instructions for causing the computer to execute: (a) a step of, for each user, rendering a virtual line on a map of a specific area using position information and direction information based on map information of the specific area and on grid information identifying a plurality of sections set in the area, and identifying sections through which the virtual line passes, the position information and the direction information being acquired for each user from a device owned by the user and identifying a position of the user and a direction in which the user is facing, respectively, and the virtual line being defined by the position information and the direction information; (b) a step of, for each identified section, adding a score in accordance with the virtual lines passing through the section, and calculating the added score as an interest degree; and (c) a step of selecting one of the identified sections based on the calculated interest degrees, and extracting the selected section as a site of interest to the plurality of users.

### (Supplementary Note 18)

The computer-readable recording medium according to Supplementary note 17, further causing the computer to execute (d) a step of displaying the site of interest to the plurality of users extracted in step (c) on a screen of an external display device.

### (Supplementary Note 19)

The computer-readable recording medium according to Supplementary note 9 or 10, wherein in step (c), a section for which the highest interest degree has been calculated is selected.

### (Supplementary Note 20)

The computer-readable recording medium according to Supplementary note 18 or 19, wherein in step (a), the virtual lines are rendered from start points to set end points in directions identified by the direction information, the start points being positions identified by the position information.

### (Supplementary Note 21)

The computer-readable recording medium according to any one of Supplementary notes 17 to 20, wherein in step (a), the sections through which the virtual lines pass are identified based on a preset condition.

### (Supplementary Note 22)

The computer-readable recording medium according to Supplementary note 21, wherein the preset condition in step (a) is externally set and includes at least one of a restriction on the virtual lines according to a time frame during which the position information and the direction information are acquired, a restriction on the virtual lines according to sections of passage, and a restriction on a part of the plurality of users.

### (Supplementary Note 23)

The computer-readable recording medium according to any one of Supplementary notes 17 to 22, wherein in step (b), the score is added for each identified section such that the larger the number of the virtual lines passing through the section, the higher the score.

### (Supplementary Note 24)

The computer-readable recording medium according to any one of Supplementary notes 17 to 22, wherein in step (b), for each identified section, pairs each consisting of two virtual lines are set by pairing all of the virtual lines passing through the section with one another, a score is assigned to each pair based on a temporal relationship and on a positional relationship between the two virtual lines, the scores of all of the pairs set for the section are summed, and a resultant sum total is used as the interest degree of the section.

While the invention of the present application has been described with reference to the above embodiments and working examples, the invention of the present application is by no means limited to the above embodiments and working examples. The configurations and details of the invention of the present application are subject to various changes that can be understood by a person skilled in the art within a scope of the invention of the present application.

The present application claims the benefit of priority from Japanese Patent Application No. 2011-177512, filed Aug. 15, 2011, the disclosure of which is incorporated herein by reference in its entirety.

### INDUSTRIAL APPLICABILITY

The present invention can be used in, for example, marketing activities and advertising strategies based on the result of extraction of an object and a place of interest to many people. More specifically, the present invention can be applied, for example, in the planning of advertising activities for a specific facility in more detail by observing temporal changes of interest degrees, and in the quantitative analysis of advertising effects of an advertising billboard set in a specific place by finding out interest degrees around the billboard.

### DESCRIPTIONS OF REFERENCE NUMERALS

1 LINE-OF-SIGHT INFORMATION ACQUISITION UNIT
2 LINE-OF-SIGHT INFORMATION STORAGE UNIT
3 GRID INFORMATION STORAGE UNIT
4 PASSAGE SECTION IDENTIFICATION UNIT
5 INTEREST DEGREE CALCULATION UNIT
6 SITE OF INTEREST EXTRACTION UNIT
10 SITE OF INTEREST EXTRACTION APPARATUS
11 TERMINAL
12 SITE OF INTEREST PRESENTATION UNIT
13 DISPLAY DEVICE
14 CONDITION SETTING UNIT
20 USER
21 TERMINAL DEVICE
22 SERVICE CUSTOMER
30 NETWORK
40 MAP
41 LINE OF SIGHT
42 GRID
43 GRID THROUGH WHICH LINE OF SIGHT HAS PASSED
43a GRID WITH HIGHEST INTEREST DEGREE
44 SITE OF INTEREST
50 SITE OF INTEREST EXTRACTION APPARATUS
51 PASSAGE SECTION IDENTIFICATION UNIT
60 SITE OF INTEREST EXTRACTION APPARATUS
61 PASSING LINE OF SIGHT STORAGE UNIT
62 INTEREST DEGREE CALCULATION UNIT
110 COMPUTER
111 CPU
112 MAIN MEMORY
113 STORAGE DEVICE
114 INPUT INTERFACE
115 DISPLAY CONTROLLER
116 DATA READER/WRITER
117 COMMUNICATION INTERFACE
118 INPUT DEVICE
119 DISPLAY DEVICE
120 RECORDING MEDIUM
121 BUS

What is claimed is:

1-10. (canceled)

11. An interest degree calculation apparatus, including:
an interest degree calculation unit that, using a virtual line on a per-user basis that is defined by position information and the direction information, for each section set in the specific area, adds a score in accordance with the virtual lines passing through the section, and calculates the added score as an interest degree of users, the position information and the direction information being acquired for each user and identifying a position of the user and a direction in which the user is facing, respectively.

12. An interest degree calculation method, including: a step of, using a virtual line on a per-user basis that is defined by position information and the direction information, for each section set in the specific area, adding a score in accordance with the virtual lines passing through the section, and calculating the added score as an interest degree of users, the position information and the direction information being acquired for each user and identifying a position of the user and a direction in which the user is facing, respectively.

13. A computer-readable recording medium having recorded therein a program using a computer, the program including instructions for causing the computer to execute: a step of, using a virtual line on a per-user basis that is defined by position information and the direction information, for each identified section set in the specific area, adding a score in accordance with the virtual lines passing through the section, and calculating the added score as an interest degree of users, the position information and the direction information being acquired for each user and identifying a position of the user and a direction in which the user is facing, respectively.

14. The interest degree calculation apparatus according to claim 11, further including:
a site of interest extraction unit that selects one of the sections based on the calculated interest degrees, and extracts the selected section as a site of interest to the plurality of users.

15. The interest degree calculation apparatus according to claim 11, wherein the section is set based on map information of the specific area and on grid information in the area.

16. The interest degree calculation apparatus according to claim 15, further including:
a passage section identification unit that, identifies sections through which the virtual line passes,
wherein the interest degree calculation unit, for each identified section, adds the score in accordance with the virtual lines passing through the identified section.

17. The interest degree calculation apparatus according to claim 16, wherein,
the passage section identification unit renders the virtual line on the map of the specific area to identify sections through which the virtual line passes.

18. The interest degree calculation apparatus according to claim 17, wherein the passage section identification unit renders the virtual lines from start points to set end points in directions identified by the direction information, the start points being positions identified by the position information.

19. The interest degree calculation apparatus according to claim 17, wherein the passage section identification unit identifies the sections through which the virtual lines pass based on a preset condition.

20. The interest degree calculation apparatus according to claim 19, wherein the preset condition is externally set and includes at least one of a restriction on the virtual lines according to a time frame during which the position information and the direction information are acquired, a restriction on the virtual lines according to sections of passage, and a restriction on a part of the plurality of users.

21. The interest degree calculation apparatus according to claim 11, wherein the interest degree calculation unit adds the score for each section such that the larger the number of the virtual lines passing through the section, the higher the score.

22. The interest degree calculation apparatus according to claim 11, wherein for each section, the interest degree calculation unit sets pairs each consisting of two virtual lines by pairing all of the virtual lines passing through the section with one another, assigns a score to each pair based on a temporal relationship and on a positional relationship between the two virtual lines, sums the scores of all of the pairs set for the section, and uses a resultant sum total as the interest degree of the section.
